(19) United States
(12) Patent Application Publication
(10) Pub. No.: US 2015/0049062 A1
(43) Pub. Date: Feb. 19, 2015

(54) MOTION GESTURE SENSING MODULE AND MOTION GESTURE SENSING METHOD

(71) Applicant: SILICON COMMUNICATIONS TECHNOLOGY CO., LTD, Songpa-gu, Seoul (KR)

(72) Inventors: Suk-Ki Kim, Gangnam-gu (KR); Yong-Sin Kim, Jung-gu (KR); Ho-Yeong Park, Seongbuk-gu (KR); Kwang-Jae Lee, Seodaemun-gu (KR)

(21) Appl. No.: 14/388,066

(22) PCT Filed: Mar. 26, 2013
(86) PCT No.: PCT/KR2013/002512

§ 371 Date: Sep. 25, 2014

(30) Foreign Application Priority Data
Mar. 26, 2012 (KR) 1020120030668
Feb. 20, 2013 (KR) 1020130018300

(51) Int. Cl. G06F 3/042; G06F 3/01

(52) U.S. Cl. CPC G06F 3/0421; G06F 3/017; G06F 2203/04108
USPC 345/175

(57) ABSTRACT

A motion gesture sensing module includes a light source emitting light, and a light sensor unit including at least two optical detectors sensing light reflected from a subject, in which an optical block is disposed in a light receiving path of the light sensor unit and individually separates a detectable zone of each of the optical detectors, thereby determining a motion or gesture of the subject based on output of the light sensor unit. Further, a motion gesture sensing method is a contactless motion sensing method, in which a light source emits light, light reflected from a subject is received by at least two optical detectors, and output values of respective optical detectors are compared to determine a motion of a subject, thereby sensing motion gesture of the subject by individually separating a detectable zone of the optical detector and receiving the light reflected from the subject.

### TECHNICAL FIELD

The present invention relates to a motion gesture sensing module and a motion gesture sensing method, in which light is emitted from a light source and the light reflected from a subject is detected to sense relative motion between the subject and the sensing module.

### BACKGROUND ART

Recently, portable devices such as smart phones, tablet personal computers (PC), media players, electronic readers, and the like have rapidly increased in popularity, and such portable devices have become necessities of modern life. With exponential growth in popularity of the portable device, technology for human-machine interfaces (HMIs) has been variously developed.

Conventional HMIs have been generally realized by a keypad disposed in the portable device. However, technology for a user interface based on a touch sensor has recently been developed and entered widespread use, and technology for a user interface based on a motion sensor for sensing a user's motion has also been developed. In a portable terminal provided with the motion sensor, when a user applies a motion to the portable terminal, the portable terminal senses his/her motion and performs a function corresponding to the motion.

Human-machine interfaces may be classified into a touch-based system, a motion-based system, a vision-based system, and a proximity-based system.

The touch-based system is used by touching a touch panel with a finger or a pen. However, if a user is wearing a glove or his hand is wet or dusty, touch is not properly sensed. In addition, the vision-based system employs a built-in camera and image processing such that a user can perform basic operation for interfacing without touching a device. However, such a vision-based system has a grave shortcoming of consuming a great deal of power.

To solve the problems of such typical interface systems, a proximity-based motion gesture sensor (MGS) system has been investigated. The recently investigated proximity-based motion gesture sensing system includes two light emitting diodes (LEDs) and one infrared (IR) photodiode disposed in a portable device as shown in FIG. 1.

The motion gesture sensor system is capable of sensing contactless operation with low power consumption. The intensity of reflected light can vary depending upon distance and angle between a subject and light sources, and motion gesture sensing algorithm may be used to sense simple gestures. The motion gesture sensor system is flexible with regard to height h, but the minimum width w of the sensor system is limited by the distance between two light sources (see FIG. 2). If a form factor (FF) is defined as a boundary factor, such a sensor system requires three individual locations for the light sources and the proximity sensor, causing the form factor to be so large as to restrict design of and the portable device.

### DISCLOSURE

### Technical Problem

The present invention is conceived to solve such problems in the art, and it is an aspect of the present invention to provide a motion gesture sensing module and a motion gesture sensing method, in which inexpensive light sources and optical detectors are used to accurately sense gestures with low power consumption.

### Technical Solution

Depending upon one aspect of the present invention, a motion gesture sensing module includes: a light source emitting light; and a light sensor unit including at least two optical detectors sensing light reflected from a subject, wherein each of the optical detectors of the light sensor unit has an individually separated detectable zone.

The motion gesture sensing module may include an optical block disposed in a light receiving path of the light sensor unit and separating a detectable zone of each of the optical detectors.

The optical block may be arranged to increase a detectable zone of each of the optical detectors while decreasing a gray zone in which fields of view (FOVs) of the respective optical detectors overlap.

The optical block may include an inner-wall type optical block disposed between the respective optical detectors, wherein the inner-wall type optical block comprises an upright optical block, an optical block having an extended portion bent at an upper end thereof in a horizontal direction, or an oblique optical block having a horizontal cross-section, the area of which increases upward. In addition, the inner-wall type optical block may have a bottom separated from an upper end of the light sensor unit.

The optical block may include an outer-wall type optical block disposed at an outer circumference of the optical detector, wherein the outer-wall type optical block may be an upright optical block, an optical block having an extended portion bent inward at an upper end thereof in a horizontal direction, or an oblique optical block having a horizontal cross-section, the area of which increases upward.

In the motion gesture sensing module, the light sensor unit may include at least three optical detectors, and at least two optical detectors may be arranged in horizontal or vertical directions to detect relative motion of a subject moving along multiple axes.

The motion gesture sensing module may include an optical block disposed in a light receiving path of the light sensor unit and separating a detectable zone of each of the optical detectors. The optical block may include an inner-wall type optical block disposed between the respective optical detectors, or an outer-wall type optical block disposed at an outer circumference of the optical detector, or both the inner-wall type optical block and the outer-wall type optical block. In addition, the outer-wall type optical block may include a bent optical block having an extended portion on a top thereof in a horizontal inward direction.

In the motion gesture sensing module, the light source and the light sensor unit may be disposed in a package partitioned by a partition wall, and an inner-wall type optical block may be disposed between the optical detectors on the light sensor unit. The inner-wall type optical block may be an upright optical block, an optical block having an extended portion bent at an upper end thereof in a horizontal direction, or an oblique optical block having a horizontal cross-section, the area of which increases upward. The light sensor unit may include an optical sensor chip including at least two optical detectors.

In the motion gesture sensing module, the optical block may include a partition wall of a package on which the light sensor unit is mounted. The partition wall may be an upright partition wall disposed at an outer circumference of the light sensor unit, a partition wall having an extended portion bent inward at an upper portion thereof, or an oblique partition wall having a horizontal cross-section, the area of which increases upward

In the motion gesture sensing module, the light sensing unit may be mounted on the package, and the package may include a partition wall surrounding an outer circumference of the light sensor unit, and a cover connected to the partition wall, formed with at least one light receiving hole and covering the light sensor unit as an optical block. The cover may include an extended portion bent inward at an upper portion of the partition wall.

The optical block may be arranged to increase a detectable zone of each of the optical detectors while decreasing a gray zone in which fields of view (FOVs) of the respective optical detectors overlap.

In addition, the cover formed with at least one light receiving hole may partially cover each of the optical detectors and partially expose each of the optical detectors through the light receiving hole. Further, a boundary of the light receiving hole may be placed over a center of each of the optical detectors.

The light sensor unit may include an optical sensor chip including at least two optical detectors.

The light sensor unit may include at least three optical detectors, at least two of which are arranged in horizontal or vertical directions to detect relative motion of a subject moving along multiple axes.

The motion gesture sensing module may include a package including two accommodation spaces; and a light sensor unit and a light source respectively mounted in the accommodation spaces of the package, wherein the package includes a partition wall surrounding an outer circumference of the light sensor unit, and a cover connected to the partition wall, formed with at least one light receiving hole and covering the light sensor unit as an optical block. At this time, the light sensor unit includes an optical sensor chip including at least two optical detectors. Further, the cover may include an extended portion bent inward at an upper portion of the partition wall. The optical block may increase a detectable zone of each of the optical detectors while decreasing a gray zone in which fields of view (FOVs) of the respective optical detectors overlap. In addition, the cover formed with at least one light receiving hole may partially cover each of the optical detectors and partially expose each of the optical detectors through the light receiving hole. Further, a boundary of the light receiving hole may be placed over a center of each of the optical detectors.

In addition, the light sensor unit may include at least three optical detectors, at least two of which are arranged in horizontal and vertical directions to detect relative motion of a subject moving along multiple axes.

Depending upon another aspect of the present invention, a motion gesture sensing module includes: a light source emitting light; and a light sensor unit including at least two optical detectors sensing light reflected from a subject, in which a plurality of sectional optical blocks is disposed above each of the optical detectors and individually separates a detectable zone of each of the optical detectors. At this time, a direction of a field of view (FOV) is set depending upon shapes of the sectional optical blocks or arrangement of the sectional optical blocks.

Depending upon a further aspect of the present invention, a motion gesture sensing module includes: a light source emitting light; a light sensor unit including at least two optical detectors sensing light reflected from a subject; and a sensor processor transmitting an output of the light sensor unit to a motion determiner, wherein the sensor processor includes an amplifier and a comparator, the amplifier includes a differential circuit to transmit a differential waveform to the comparator, and the comparator is operated based on comparison with the received differential waveform. Here, the comparator may include a hysteresis comparator.

Depending upon yet another aspect of the present invention, there is provided a motion gesture sensing method that is a contactless motion sensing method, in which a light source emits light, light reflected from a subject is received by at least two optical detectors, and outputs of respective optical detectors are compared to determine a motion of a subject. The method includes sensing the motion of the subject by individually separating a detectable zone of each of the optical detectors and receiving the light reflected from the subject. At this time, an optical block disposed in a light receiving path of the optical detector may be used to individually separate the detectable zone of each of the optical detectors and arranged to increase a detectable zone of each of the optical detectors while decreasing a gray zone in which fields of view (FOVs) of the respective optical detectors overlap.

### Advantageous Effects

According to the present invention, a motion gesture sensing module which is inexpensive, consumes lower power and has a micro size can be realized using a low-cost light source and optical detector.

In addition, according to the present invention, a motion gesture sensing method capable of accurately sensing a gesture in response to change in quantity of light by a subject can be realized.

Particularly, according to the present invention, the motion gesture sensing module includes at least two optical detectors and an optical block disposed in a light receiving path to divide a detectable zone of each of the optical detectors and to accurately measure change in quantity of light due to relative motion between a subject and a module, thereby sensing the relative motion or gesture between the subject and the module. In addition, the motion gesture sensing module decreases a gray zone in which detection angles of the optical detectors overlap, while increasing the detectable zone, thereby enabling accurate and sensitive sensing of motion and gesture.

Further, the motion gesture sensing module and method according to the present invention can sense not only relative motion or gesture of a subject, but also a spatial touching function, like a click operation of a mouse, and can determine proximity of the subject, thereby providing advantages of performing all functions of an existing proximity sensor (for example, proximity sensing, reading mode, power saving function, and the like). Accordingly, the motion gesture sensing module according to the present invention may be utilized as an input device for various functions in a mobile device, such as cellular phones, tablet PCs, and the like.

### DESCRIPTION OF DRAWINGS

FIGS. 1 and 2 are views of a conventional motion gesture sensing module.

FIG. 3 is a view showing a time margin of the conventional motion gesture sensing module.

FIGS. 4 to 8 are views illustrating an operation principle of a motion gesture sensing module according to the present invention.

FIG. 9 is a view showing various examples of a motion gesture sensing module according to a first embodiment of the present invention.

FIG. 10 is a view showing various examples of a motion gesture sensing module according to a second embodiment of the present invention.

FIG. 11 is a view showing various examples of a motion gesture sensing module according to a third embodiment of the present invention.

FIGS. 12 and 13 are views showing various examples of a motion gesture sensing module according to a fourth embodiment of the present invention.

FIGS. 14 to 17 are views of an optical block and an optical sensor chip according to the present invention.

FIG. 18 is an exploded perspective view of a motion gesture sensing module according to a fifth embodiment of the present invention.

FIG. 19 is a cut-away perspective view of the motion gesture sensing module according to the fifth embodiment of the present invention.

FIG. 20 is a plan view of the motion gesture sensing module according to the fifth embodiment of the present invention.

FIG. 21 is a plan perspective view explaining an optical sensor chip and a light receiving hole of the motion gesture sensing module according to the fifth embodiment of the present invention.

FIGS. 22 and 23 are views of different optical sensor chips embodied by the principle of the optical block according to the present invention.

FIGS. 24 to 26 are views of a sensor processor according to the present invention.

### BEST MODE

Hereinafter, embodiments of the present invention will be described with reference to the accompanying drawings.

It should be understood that the present invention is not limited to the following embodiments and may be embodied in different ways, and that the embodiments are provided for complete disclosure and thorough understanding of the invention by those skilled in the art.

The present invention provides a motion gesture sensing module, which is inexpensive, consumes low power and has a micro size, and a motion gesture sensing method. According to the present invention, the motion gesture sensing module includes at least one light source and a plurality of optical detectors. Light emitted from the light source is reflected from the subject and received by the optical detectors, and sensing results of the respective optical detectors are calculated to obtain a subject's motion or gesture (in this embodiment, the subject's motion or gesture includes relative motion between the sensing module and the subject, i.e. the subject's motion or gesture includes movement of the sensing module with respect to a stationary subject and movement of the subject with respect to the sensing module).

According to the present invention, the motion gesture sensing module and method are realized by emitting light and receiving light reflected from the subject. Light may be emitted from the light source and detected through the optical detectors. Here, infrared light may be generally used as light, without being limited thereto. Further, light having various wavelengths, such as ultraviolet light, visible light, X-rays, and the like as well as infrared light may be used so long as the principle of the present invention can be applied.

According to the present invention, a photodiode (PD) may be used as the optical detector. Alternatively, the optical detector may be realized by various means so long as they can sense light. A light emitting diode (LED) may be generally used as the light source. Alternatively, the light source may be realized by any means so long as they can emit light.

To calculate motion or gesture of a subject through the motion gesture sensing module, there must be a difference between output values (for example, intensity of light), which are sensed in response to the motion or gesture of the subject, of the respective optical detectors. To this end, according to the present invention, various means and methods are used for separating detectable zones (that is, dividing detectable zones) in which a plurality of optical detectors can receive the light. As used herein, the detectable zone refers to an angle or region in which each of the optical detectors can receive light reflected from the subject. The division of the detectable zone for the optical detector means that each of the optical detectors has a corresponding detectable zone for sensing the light reflected from the subject. For example, if there are an optical detector A and an optical detector B, a zone detectable only by the optical detector A is formed separately from a zone detectable only by the optical detector B. As the detectable zones for the plural optical detectors are separated from each other (that is, divided from each other), output values of the optical detectors differ depending upon relative motion between the motion gesture sensing module and the subject, and calculated to sense the motion or gesture of the subject.

According to the present invention, there are provided means and a method for separating the detectable zones for the plural optical detectors. This means and method may be realized in various ways within the scope of the present invention.

A motion gesture sensing module according to one embodiment of the present invention may employ an optical block as one example of the means for separating the detectable zones for the plural optical detectors.

In this embodiment, the optical block serves to separate the detectable zones in which each of the optical detectors can sense light reflected from the subject.

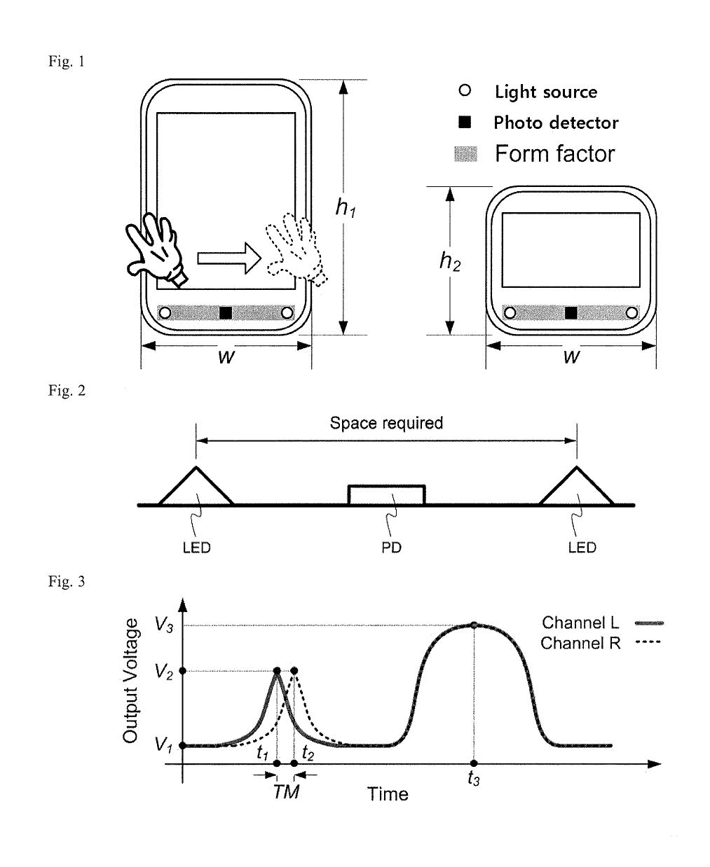

According to one embodiment of the present invention, the motion gesture sensing module includes a plurality of photodiodes (PD), one light emitting diode (LED), and an optical block. Here, the optical block is arranged to separate detectable zones such that that the detectable zones can be respectively assigned to the plurality of photodiodes (PD), and receive infrared light reflected from a subject, thereby sensing motion of the subject relative thereto. With this structure, the motion gesture sensing module can be manufactured, regardless of a distance between two photodiodes for sensing an object's motion, unlike the module shown in FIG. 1(b).

Now, a principle of arranging the optical block according to the present invention will be described with reference to FIGS. 3 to 8.

According to the present invention, a new proximity-based motion gesture sensor including two optical detectors and embedded on a single chip having an off-chip light source will be described. Conventionally, when a subject moves, time delay between light received from light sources is detected, and thus a certain distance between the two light sources is needed for a minimum detection margin. On the other hand, according to the present invention, only one light source is needed since the optical block can separate detectable zones for two optical detectors with regard to light reflected from a subject. Here, if a distance between the two light sources of the conventional system is 40 mm, a distance between the single light source and the proximity sensor of the present sensing system becomes 4 mm, and the form factor is decreased by 1/10.

Basically, a motion gesture is extracted from output data of a proximity sensor in the proximity-based gesture sensor system. FIG. 3 shows one example of output data from the proximity sensor. Depending upon a user's motion gesture, the output data shows different patterns and a time margin (TM), which may be used in extraction of various motion gestures. With regard to horizontal swipes and push/pull gestures, the time margin and the gradient of the output voltage may be used, respectively.

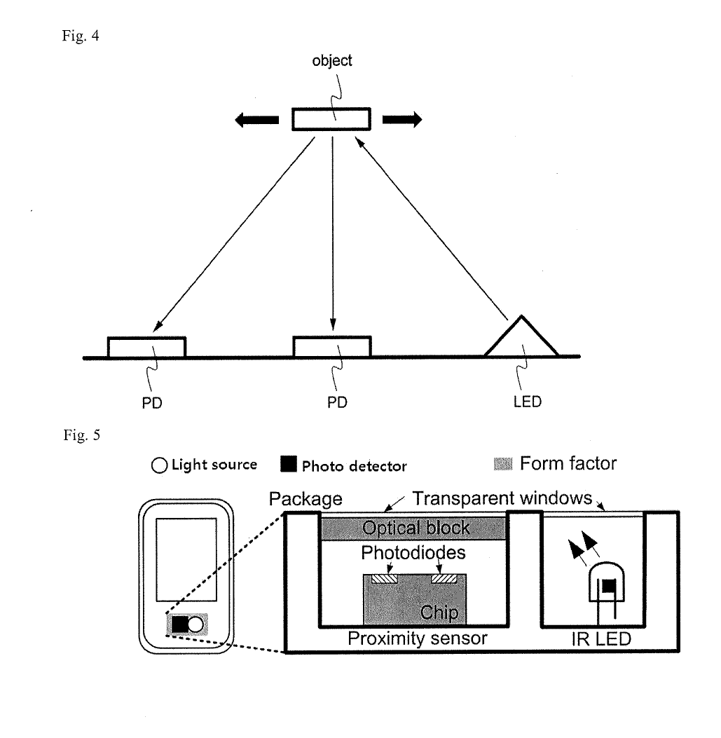

A motion gesture sensing module according to one embodiment of the present invention may be realized by the proximity sensor that includes two optical detectors and a single light source, as shown in FIGS. 4 and 5. The motion gesture sensing module according to the embodiment of the present invention may be freely designed regardless of the form factor, since it has a much smaller form factor (FF) than that of the conventional system including two light sources. The proposed motion gesture sensing module according to the embodiment of the present invention serves to detect the intensity of infrared light reflected from a subject, like a conventional proximity-based gesture sensor system. However, the time margin (TM) will be increased as the proposed optical block is used to separate the detectable zones for two optical detectors.

In the present invention, a packaging partition wall for packaging a sensor chip may serve as the optical block, and an additional optical block may be configured, as shown in FIG. 5.

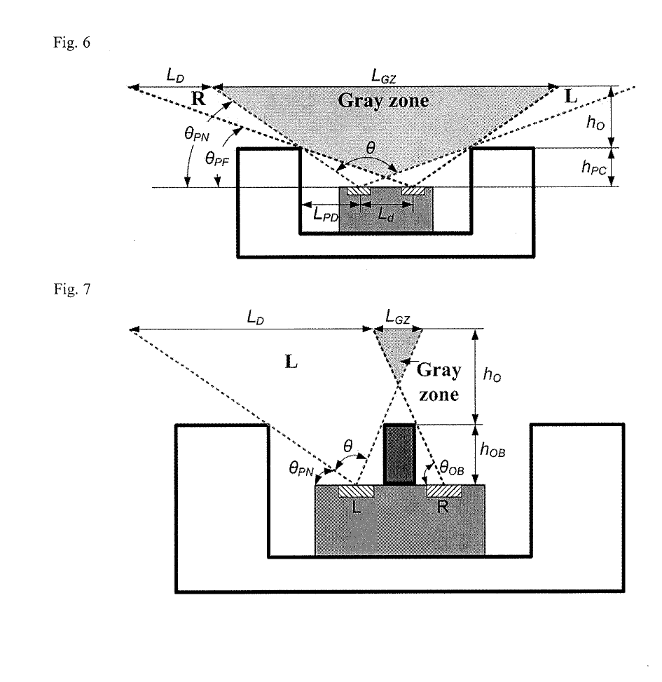

A basic configuration of the motion gesture sensing module according to one embodiment of the invention includes two optical detectors in a single package, and a field of view (FOV) of each of the optical detectors is defined as an angle for receiving light reflected from a subject, as shown in FIG. 6. In FIG. 6, θ is the FOV of the optical detector. The detectable zones R (channel R) and L (channel L) and the gray zone are determined by the FOVs of the two optical detectors. As the motion gesture sensing module according to the embodiment of the invention, FIG. 6 shows that the detectable zones R (channel R) and L (channel L) of two optical detectors are separated by the package partition walls. That is, as shown in FIG. 6, the detectable zones R (channel R) and L (channel L) are separated into left and right zones.

As used herein, the gray zone refers to a region in which the FOVs of two optical detectors overlap. When a subject moves from the left side of the R zone to the right side of the L zone, detection is operated in an opposite way to the proximity sensor data shown in FIG. 3. This is referred to as reverse detection. The length (LD) of the detectable zone may be defined by Equation 1.

$${L}_{D} = ( {h}_{O} + {h}_{PC} ) ( \frac{1}{tan {θ}_{PF}} - \frac{1}{tan {θ}_{PN}} ) - {L}_{d} \qquad 〈 Equation 1 〉$$

Here, hₒ is a height between a subject and an upper end of the package, h_{pc} is a height between the upper end of the package top and an upper end of the chip, θ_{PN} is a viewing angle restricted by a near package partition wall, θ_{PF} is a viewing angle restricted by a far package partition wall, and L_{d} is a distance between two optical detectors. Since θ_{PF} and θ_{PN} are correlation variables determined by the size of the package, L_{D} may be defined again by Equation 2, excluding θ_{PF}.

$${L}_{D} = \frac{{L}_{d} \cdot ( {h}_{O} + {h}_{PC} )}{{L}_{PD} \cdot tan {θ}_{PN}} - {L}_{d} \qquad 〈 Equation 2 〉$$

Here, L_{PD} is a distance between the optical detector and the near package partition wall. If left/right swipe and push/pull gesture of the subject are generated within the gray zone, it is impossible to detect this gesture. Here, the length L_{GZ} of the gray zone may be determined by Equation 3.

$${L}_{GZ} = \frac{2 \cdot ( {h}_{O} + {h}_{PC} )}{tan {θ}_{PN}} - {L}_{d} \qquad 〈 Equation 3 〉$$

The detectable distance L_{D} increases as the subject becomes more distant from the chip, but L_{GZ} will increase since L_{D} is caused by L_{d}/L_{PD}<2 from Equation 2 and Equation 3. If the subject moves at a velocity of v_{O}, the time margin TM is represented by Equation 4.

TM=L_{D}/v_{O} <Equation 4>

In a conventional system employing two light sources, the time margin TM is proportional to a distance between two LEDs (usually, several centimeters). If the proposed optical block is not considered, the time margin TM of the proposed single light source system will be calculated by an equation in terms of a space (smaller than several hundred micrometers) between two optical detectors, and largely decreased, as compared with that of the conventional motion gesture sensor system.

In the proposed configuration, the optical block as shown in FIG. 7 is proposed in order to increase the time margin TM of the foregoing basic configuration. The FOVs of two optical detectors adjusted by the optical block will increase the detectable zones while decreasing the gray zone. In this proposed configuration, L_{D} is represented by Equation 5.

$${L}_{D} = ( {h}_{O} + {h}_{OB} ) ( \frac{1}{tan {θ}_{PN}} - \frac{1}{tan {θ}_{OB}} ) + {L}_{d} \qquad 〈 Equation 5 〉$$

Here, θ_{OB} is a viewing angle restricted by the proposed optical block, and θ_{PN} and θ_{OB} are adjusted by the height and length of the package and the proposed optical block. The length L_{GZ} of the gray zone is obtained by Equation 6.

$${L}_{GZ} = \frac{2 \cdot ( {h}_{O} + {h}_{OB} )}{tan {θ}_{OB}} - {L}_{d} \qquad 〈 Equation 6 〉$$

Since θ_{PN} and θ_{OB} are independent of Equation 5, the proposed structure may increase L_{D} while L_{GZ} is decreased by simply increasing θ_{OB}. As a result, the time margin is increased by a small distance between two optical detectors. The maximum θ_{OB} is limited by real dimensions corresponding to the height and length of the optical block.

To properly sense motion, the minimum θ_{OB} must be determined by L_{GZ} at a maximum allowable height h_{Omax} of the subject. This is shorter than the length of the subject and operates as in Equation 7.

L_{GZ}≦L_{O}+ΔL_{O} <Equation 7>

Here, L_{O} and ΔL_{O} represent the length and motion of the subject, respectively. From Equation 6 and Equation 7, the minimum approximate value of θ_{OB} is extracted by Equation 8.

$${θ}_{OB} \leq arctan ( \frac{2 \cdot {h}_{O}}{{L}_{O} + Δ {L}_{O}} )$$

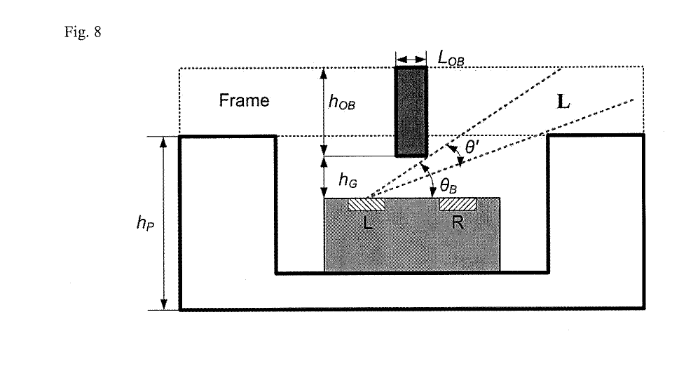

The proposed optical block is shown in FIG. 8. The optical block may be formed as a top frame on the upper end of the package. In practical design, there may be a gap between the optical block and a protective frame. This gap causes a parasitic FOV (θ′) and thus receives infrared ray reflected from the opposite side of the zone. To eliminate this parasitic FOV, the viewing angle (θB) of the optical detector restricted by the bottom of the optical block must be smaller than the viewing angle restricted by the far package partition wall. Such a condition is represented by Equation 9.

tan θ_{B}/tan θ_{PF} <Equation 9>

If the foregoing condition is not satisfied, the discussed reverse detection can previously decrease the time margin TM.

Now, various examples of the structure of the motion gesture sensing module according to the present invention will be described based on the system in which a single light source emits light and a plurality of optical detectors receives the light reflected from a subject.

In particular, according to the present invention, various examples will be described with regard to the various structures of the optical block in which the optical block blocks light reflected from the subject and received by the optical detector, in other words, the detectable zones of the respective optical detectors are separated by restricting the FOV of the optical detectors.

First, the motion gesture sensing module according to the present invention may include a single light source for generating light, a light sensor unit including at least two optical detectors for receiving light emitted from the light source and converting the light into electric energy, and an optical block disposed in a light receiving path of the light sensor unit and separating a detectable zone for each of the optical detectors.

Here, the optical block is disposed for blocking some of light reflected from the subject and received by the optical detector, and restricting the FOV of each of the optical detectors, thereby separating the detectable zones. As described in some embodiments, the optical block may be a separate structure disposed in the light receiving path of the optical detector and used only for restricting the FOV. In addition, as described in other embodiments, a part of a package for protecting a built-in light sensor unit may perform functions of the optical block. These various embodiments will be described with reference to the accompanying drawings.

The motion gesture sensing module according to the embodiment of the invention is operated such that light emitted from the light source is reflected from the subject and received by the optical detector. As used herein, the term “light” may be infrared light, without being limited thereto. Alternatively, light may include ultraviolet light, visible light, radio waves, microwaves, X-rays, sound waves, ultrasonic waves, and the like within the scope of the present invention. In the following embodiments, infrared light will be described as the light. However, it will be understood that the present invention is not limited thereto.

The motion gesture sensing module according to the embodiment of the invention receives light reflected from the subject and thus detects relative motion between the subject and the module. Therefore, both when the subject moves with regard to a stationary device disposed with the motion gesture sensing module and when a device disposed with the gesture sending module moves with regard to a stationary subject, these movements can be sensed as the relative motions.

The light source converts electric energy into light energy, and emits the light energy to an approaching subject.

Here, the light source may be realized by a light emitting diode (LED) that emits light by application of electric current. In particular, according to the present invention, the LED may be an infrared LED. In this case, infrared light may have a wavelength of 840 nm or 940 nm, without being limited thereto. Alternatively, light having various wavelengths may be used within the scope of the present invention.

The light sensor unit serves to convert light energy into electric energy. The light sensor unit receives light emitted from the light source and light reflected from the subject, and converts the light into electric energy. Such a light sensor unit may include at least two optical detectors.

The optical detector may be realized by a photodiode for converting light into electric energy. In particular, according to the present invention, the photodiode may be suitable for detecting infrared light.

The optical block is disposed in the light receiving path of the optical detector and is disposed around the light sensor unit, thereby blocking some light.

In particular, if the optical block is disposed around the light sensor unit, the corresponding optical block restricts the FOVs of the optical detectors within the light sensor unit and separates the detectable zones of the optical detectors. Further, the optical block increases the detectable zone while decreasing the gray zone in which the FOVs of the respective optical detectors overlap, thereby accurately sensing the gesture. In other words, the optical block serves to cut off a partial light receiving path of the light reflected from the subject and received by the optical detectors. That is, the optical block is disposed to partially cut off the light receiving path of each of the optical detectors.

In addition, if the optical block 70 is disposed around the light source, the optical block may serve to restrict a radiation angle of the light source. In other words, the optical block may be a structure for partially blocking light emitted from the light source.

Next, various structures of the light source, the light sensor unit and the optical block will be described in detail with reference to exemplary embodiments of the invention.

In the drawings corresponding to the embodiments, like numerals refer to like elements having the same functions within the scope of the present invention.

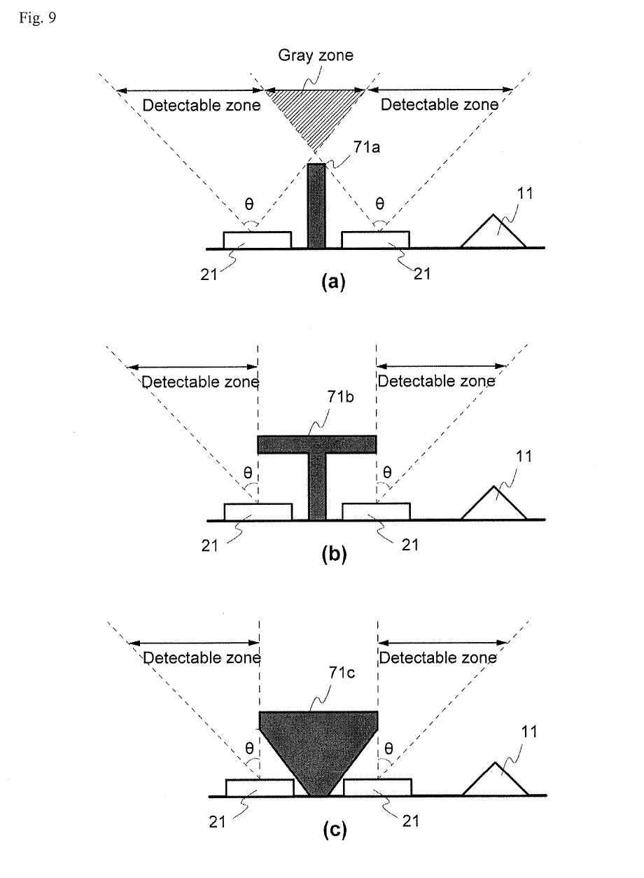

FIG. 9 is a schematic cross-sectional view showing a motion gesture sensing module according to a first embodiment of the present invention.

The motion gesture sensing module according to the first embodiment includes a single light source 11, a light sensor unit 20 including at least two optical detectors 21, and an inner-wall type optical block 71 disposed between the optical detectors 21.

Although FIG. 9 schematically shows the configuration of the motion gesture sensing module, which detects motion along a single axis using two optical detectors 21 and one inner-wall type optical block 71 disposed between two optical detectors 21, it should be understood that the present invention is not limited thereto.

The motion gesture sensing module according to the present invention may also detect motion along multiple axes using at least three optical detectors 21 and inner-wall type optical blocks 71 disposed there between.

Here, the inner-wall type optical block 71 may be composed of an upright optical block 71a, a bent optical block 71b, and an oblique optical block 71c.

First, referring to FIG. 9(a), the upright optical block 71a is disposed between the two optical detectors 21.

The upright optical block 71a has a higher height than the two optical detectors 21 and serves to partially restrict FOVs (θ) of the optical detectors 21. Thus, the upright optical block 71a separates detectable zones of the two optical detectors 21, thereby decreasing the gray zone in which the FOVs (θ) of the optical detectors 21 overlap, while increasing the detectable zones.

Referring to FIG. 9(a), with this structure, each of the optical detectors 21 has its own FOV (θ) for detecting light. One side of each FOV (θ) will be restricted by the upright optical block 71a. Therefore, as compared with the case where the upright optical block 71a is not provided, the gray zone in which the FOVs (θ) of both optical detectors 21 overlap is decreased, whereas the detectable zones are increased. As a result, the upright optical block 71a disposed between the optical detectors 21 completely separates the detectable zones of both optical detectors 21 while decreasing the gray zone, thereby enabling effective detection of sensitive motion.

Here, although the gray zone can be decreased by increasing the height of the upright optical block 71a, the height of the upright optical block 71a may be restricted in consideration of a connection structure and design of a base device on which the motion gesture sensing module will be disposed. As shown in FIG. 8, the optical block 71a may have a bottom separated from an upper end of the light sensor unit.

Next, referring to FIG. 9(b), the bent optical block 71b having an extended portion bent at an upper end thereof is disposed between the two optical detectors 21.

The bent optical block 71b has a shape wherein a straight base disposed between the two optical detectors 21 is bent toward the optical detectors 21 at an upper end thereof, and the extended portion is placed above the two optical detectors 21 and restricts the FOVs (θ) of the optical detectors 21. Here, distal ends of the extended portion of the bent optical block 71b may be placed corresponding to central locations of the optical detectors 21, respectively.

Referring to FIG. 9(b), with this structure, each of the optical detectors 21 has its own FOV (θ) for detecting light. One side of each FOV (θ) will be restricted by the bent optical block 71b, thereby separating the detectable zone of each of the optical detectors. In addition, the gray zone in which the FOVs (θ) overlap is decreased or completely eliminated by adjusting the length of the extended portion bent at the upper end of the bent optical block 71b. Thus, as compared with the case where the bent optical block 71b is not provided, the gray zone in which the FOVs (θ) of both optical detectors 21 overlap is substantially reduced or eliminated, while allowing individual detectable zones to become clear. As a result, the bent optical block 71b disposed between the optical detectors 21 completely separates the detectable zones of both optical detectors 21 while decreasing the gray zone, thereby enabling effective detection of sensitive motion.

Here, as the length of the extended portion bent at the upper end of the optical block 71b increases, each FOV (θ) will be further restricted together with the detectable zones. Therefore, the length of the extended portion may be restricted in consideration of use of the motion gesture sensing module or design of a base device on which the motion gesture sensing module will be disposed.

Next, referring to FIG. 9(c), the oblique optical block 71c, a horizontal cross-section of which increases upward, is disposed between the two optical detectors 21.

The oblique optical block 71c is disposed between the two optical detectors 21 and has a horizontal cross-section, the area of which increases upward, such that lateral sides of the optical block 71c facing toward the opposite optical detectors 21 can become larger upward, thereby forming oblique lateral sides. Therefore, these lateral sides of the optical block are operated to restrict the FOVs (θ) of the optical detectors 21. Here, the oblique optical block 71 chasa higher height than the two optical detectors 21 to restrict the FOVs (θ) of the optical detectors 21. Distal ends of the largest portion at the top of the oblique optical block 71c may be placed corresponding to the central location of the optical detectors 21, respectively.

Referring to FIG. 9(c), with this structure, each of the optical detectors 21 has its own FOV (θ) for detecting light. One side of each FOV (θ) will be restricted by the oblique optical block 71c. Therefore, the gray zone in which the FOVs (θ) of both optical detectors 21 overlap may be greatly decreased or completely eliminated by adjusting the width of the oblique optical block 71c. Therefore, as compared with the case where the oblique optical block 71c is not provided, the gray zone in which the FOVs (θ) of both optical detectors 21 overlap is remarkably decreased or eliminated, while allowing individual detectable zones to become clear. As a result, the oblique optical block 71c disposed between the optical detectors 21 completely separates the detectable zones of both optical detectors 21 while decreasing the gray zone, thereby enabling effective detection of sensitive motion.

Here, as the largest portion at the top of the oblique optical block 71c increasingly protrudes, each FOV (θ) will be further restricted together with the detectable zones. Therefore, protrusion of the largest portion may be restricted in consideration of use of the motion gesture sensing module or design of a base device on which the motion gesture sensing module will be disposed.

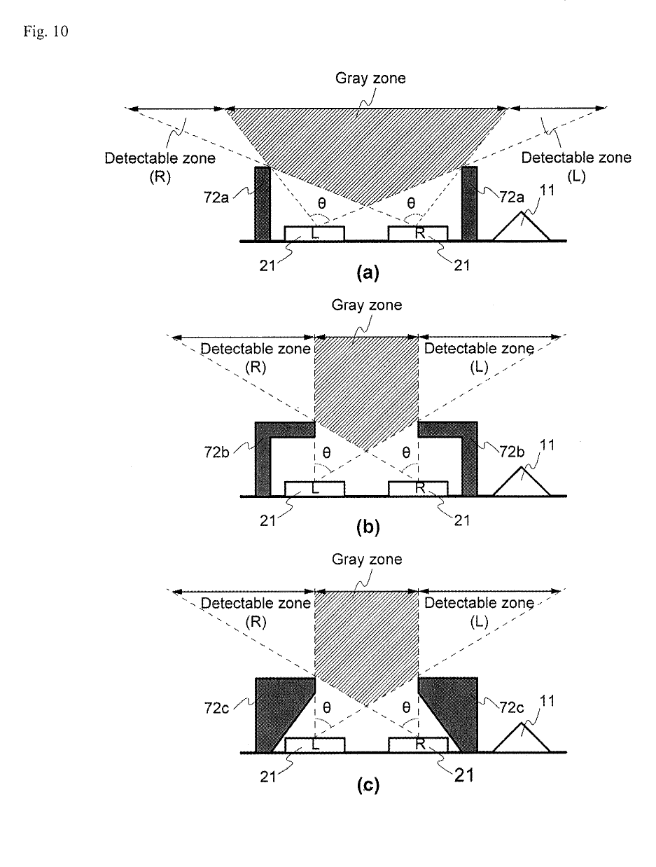

FIG. 10 is a schematic cross-sectional view of a motion gesture sensing module according to a second embodiment of the present invention.

The motion gesture sensing module according to the second embodiment includes a single light source 11, a light sensor unit 20 having at least two optical detectors 21, and outer-wall type optical blocks 72 respectively disposed at outer circumferences of the optical detectors 21.

Although FIG. 10 schematically shows the configuration of the motion gesture sensing module, which detects motion along a single axis using the two optical detectors 21 and the outer-wall type optical blocks 71 respectively disposed at left and right sides of the optical detectors 21, it should be understood that the present invention is not limited thereto. The motion gesture sensing module according to the present invention may also detect motion along multiple axes using at least three optical detectors 21 and the outer-wall type optical blocks 72 disposed at the outer circumferences of each of the optical detectors 21.

Here, the outer-wall type optical block 72 may be composed of an upright optical block 72a, a bent optical block 72b and an oblique optical block 72c.

First, referring to FIG. 10(a), the upright optical blocks 72a are disposed at the left and right sides of the two optical detectors 21, respectively.

The upright optical block 72a has a higher height than the two optical detectors 21 and serves to restrict the FOV (θ) of the optical detector 21.

Referring to FIG. 10(a), the left (L) optical detector 21 and the right (R) optical detector 21 have their own FOVs (θ) restricted by adjacent upright optical blocks 72a, respectively. Therefore, a portion in which the FOVs (θ) of both optical detectors 21 overlap becomes the gray zone, and each of the optical detectors 21 has its own detectable zone at an opposite side to its location. For example, the left (L) optical detector 21 has its own detectable zone L at a side of the right (R) optical detector 21, and the right (R) optical detector 21 has its own detectable zone R at a side of the left (L) optical detector 21.

As a result, as compared with the case where the left and right upright optical blocks 72a are not provided, the gray zone in which the FOVs (θ) of the optical detectors 21 overlap is decreased, whereas the detectable zones are separated and increased. As a result, the upright optical blocks 72a respectively disposed at the left and right sides of the optical detectors 21 separate the detectable zones of the optical detectors 21 while decreasing the gray zone, thereby enabling effective detection of sensitive motion.

Here, as the height of the upright optical block 72a increases, the gray zone will be decreased together with the detectable zones. Therefore, the height of the upright optical block 72a may be restricted in consideration of a connection structure and design of a base device on which the motion gesture sensing module will be disposed.

Next, referring to FIG. 10(b), the bent optical blocks 72b, each having an extended portion bent at an upper end thereof, are disposed at the left and right sides of the two optical detectors 21, respectively.

Each of the bent optical blocks 72b placed at opposite sides has a shape wherein a straight base is bent inward (that is, toward the optical detector) at an upper end thereof, and the extended portions are placed above the two optical detectors 21 and restrict the FOVs (θ) of the optical detectors 21. Here, distal ends of the extended portions at the upper ends of the bent optical blocks 72b may be placed corresponding to detection centers of the adjacent optical detectors 21.

Referring to FIG. 10(b), the left (L) optical detector 21 and the right (R) optical detector 21 have their own FOVs (θ) restricted by the adjacent bent optical blocks 72b, respectively. Therefore, a portion in which the FOVs (θ) of both optical detectors 21 overlap becomes the gray zone, and each of the optical detectors 21 has its own detectable zone at an opposite side to its location. For example, the left (L) optical detector 21 has its own detectable zone L at a side of the right (R) optical detector 21, and the right (R) optical detector 21 has its own detectable zone R at a side of the left (L) optical detector 21.

As a result, as compared with the case where the left and right bent optical blocks 72b are not provided, the gray zone in which the FOVs (θ) of the optical detectors 21 overlap is decreased, whereas the detectable zones are separated and increased. As a result, the bent optical blocks 72b respectively disposed at the left and right sides of the optical detectors 21 separate the detectable zones of the optical detectors 21 while decreasing the gray zone, thereby enabling effective detection of sensitive motion.

Here, as the length of the extended portion bent at the upper end of each of the bent optical blocks 72b increases, the gray zone will be decreased together with the detectable zones. Therefore, the length of the optical block 72a may be restricted in consideration of a connection structure and design of a base device on which the motion gesture sensing module will be disposed.

Next, referring to FIG. 10(c), the oblique optical blocks 72c, a horizontal cross-section of which increases upward, are disposed at the left and right sides of two optical detectors 21, respectively.

Both the oblique optical blocks 72c each have the horizontal cross-section, the area of which increases upward, such that lateral sides facing inward (that is, toward the optical detectors) can become larger upward, thereby forming oblique lateral sides. Therefore, these lateral sides of the oblique optical blocks are operated to restrict the FOVs (θ) of the optical detectors 21. Here, the largest portion at the top of the oblique optical block 72c may be formed corresponding to the central location of the optical detector 21.

Referring to FIG. 10(c), the left (L) optical detector 21 and the right (R) optical detector 21 have their own FOVs (θ) restricted by the adjacent oblique optical blocks 72c, respectively. Therefore, a portion in which the FOVs (θ) of both optical detectors 21 overlap becomes the gray zone, and each of the optical detectors 21 has its own detectable zone at an opposite side to its location. For example, the left (L) optical detector 21 has its own detectable zone L at a side of the right (R) optical detector 21, and the right (R) optical detector 21 has its own detectable zone R at a side of the left (L) optical detector 21.

As a result, as compared with the case where the left and right oblique optical blocks 72c are not provided, the gray zone in which the FOVs (θ) of the optical detectors 21 overlap is decreased, whereas the detectable zones are separated and increased. As a result, the oblique optical blocks 72c respectively disposed at the left and right sides of the optical detectors 21 separate the detectable zone of the optical detector 21 while decreasing the gray zone, thereby enabling effective detection of sensitive motion.

Here, as the largest portion at the top of the oblique optical block 72c increasingly protrudes, the gray zone will be decreased together with the detectable zone. Therefore, the largest portion may be restricted in consideration of a connection structure and design of a base device on which the motion gesture sensing module will be disposed.

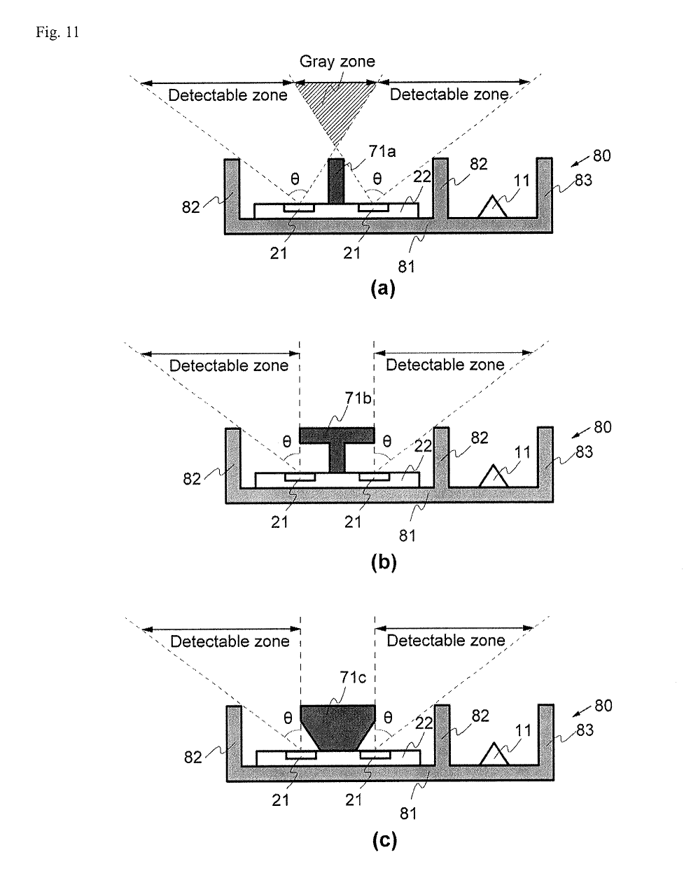

FIG. 11 is a schematic cross-sectional view of a motion gesture sensing module according to a third embodiment of the present invention.

The motion gesture sensing module according to the third embodiment includes a single light source 11, a light sensor unit 20 provided as a single optical sensor chip 22 having at least two optical detectors 21, and an inner-wall type optical block 71 disposed between the optical detectors 21. Further, the light source 11 and the optical sensor chip 22 are packaged and partitioned by a package partition wall.

Here, a package 80 may include a base 81 on which the light source 11 and the optical sensor chip 22 are mounted, sensor partition walls 82 protruding from outer circumferences of the optical sensor chip 22 to partition an installation region of the optical sensor chip 22, and a light source partition wall 83 protruding to partition an installation region of the light source 11.

Although FIG. 11 schematically shows the configuration of the motion gesture sensing module, which detects motion along a single axis using two optical detectors 21, one inner-wall type optical block 71 disposed between two optical detectors 21, and the package 80 for mounting the light source and the light sensor unit, it should be understood that the present invention is not limited thereto. The motion gesture sensing module according to the present invention may also detect motion along multiple axes using three or more optical detectors 21, the inner-wall type optical blocks 71 disposed between three or more optical detectors 21, and the package 80 for partitioning them.

Here, the inner-wall type optical block 71 may be composed of an upright optical block 71a, a bent optical block 71b, and an oblique optical block 71c.

First, referring to FIG. 11(a), the optical sensor chip 22 is mounted on the base 81 of the package 80 partitioned by the partition walls 82, the light source 11 is mounted on the base 81 of the package 80 partitioned by the partition wall 83, and one upright optical block 71a is disposed between two optical detectors 21 on the optical sensor chip 22.

The upright optical block 72a has a higher height than the two optical detectors 21 of the optical sensor chip 22 and serves to restrict the FOVs (θ) of the optical detectors 21.

Referring to FIG. 11(a), with this structure, each of the optical detectors 21 of the optical sensor chip 22 has its own FOV (θ) for detecting light. One side of each FOV (θ) will be restricted by the upright optical block 71a. Therefore, as compared with the case where the upright optical block 71a is not provided, the gray zone in which the FOVs (θ) of both optical detectors 21 overlap is decreased, whereas the detectable zones are increased. As a result, the upright optical block 71a disposed between the optical detectors 21 completely separates the detectable zones of both optical detectors 21 while decreasing the gray zone, thereby enabling effective detection of sensitive motion.

Here, although the gray zone can be decreased by increasing the height of the upright optical block 71a, the height of the upright optical block 71a may be restricted in consideration of a connection structure and design of a base device on which the motion gesture sensing module will be disposed. Preferably, the height of the upright optical block 71a is the same as that of the sensor partition wall 82.

Next, referring to FIG. 11(b), the optical sensor chip 22 is mounted on the base 81 of the package 80 partitioned by the partition walls 82, the light source 11 is mounted on the base 81 of the package 80 partitioned by the partition wall 83, and one bent optical block 71b is disposed between two optical detectors 21 on the optical sensor chip 22.

The bent optical block 71b has a shape wherein a straight base disposed between the two optical detectors 21 is bent toward the optical detectors 21 at an upper end thereof, and the extended portion is placed above the two optical detectors 21 and restricts the FOVs (θ) of the optical detectors 21. Here, distal ends of the extended portion of the bent optical block 71b may be placed corresponding to central locations of the optical detectors 21, respectively.

Referring to FIG. 11(b), with this structure, each of the optical detectors 21 has its own FOV (θ) for detecting light. One side of each FOV (θ) will be restricted by the bent optical block 71b, and the gray zone in which the FOVs (θ) overlap is substantially decreased or completely eliminated by adjusting the length of the extended portion bent at the upper end of the bent optical block 71b. Thus, as compared with the case where the bent optical blocks 71b are not provided, the gray zone in which the FOVs (θ) of both optical detectors 21 overlap is substantially reduced or eliminated, and the detectable zones are separated and increased. As a result, the bent optical block 71b disposed between the optical detectors 21 of the optical sensor chip 22 completely separates the detectable zones of both optical detectors 21 while decreases the gray zone, thereby enabling effective detection of sensitive motion.

Here, as the length of the extended portion at the upper end of the bent optical block 71b is increased, each FOV (θ) will be further restricted together with the detectable zones. Therefore, the length of extended portion may be restricted in consideration of use of the motion gesture sensing module or design of a base device on which the motion gesture sensing module will be disposed. Preferably, the height of the bent optical block 71b is the same as that of the sensor partition wall 82.

Next, referring to FIG. 11(c), the optical sensor chip 22 is mounted on the base 81 of the package 80 partitioned by the partition walls 82, the light source 11 is mounted on the base 81 of the package 80 partitioned by the partition wall 83, and one oblique optical block 71c is disposed between the two optical detectors 21 on the optical sensor chip 22.

The oblique optical block 71c is disposed between two optical detectors 21 of the optical sensor chip 22, and has a horizontal cross-section, the area of which increases upward, such that lateral sides of the oblique optical block 71c facing toward the opposite optical detectors 21 can protrude farther upward, thereby forming oblique lateral sides. Therefore, these lateral portions are operated to restrict the FOVs (θ) of the optical detectors 21. Here, the most protruding portion at the top of the oblique optical block 71c may be formed corresponding to the central location of the optical detector 21 of the optical sensor chip 22.

Referring to FIG. 11(c), with this structure, each of the optical detectors 21 has its own FOV (θ) for detecting light. One side of each FOV (θ) will be restricted by the oblique optical block 71c. Therefore, the gray zone in which the FOVs (θ) overlap may be substantially decreased or completely eliminated by adjusting the width of the oblique optical block 71c. As compared with the case where the oblique optical blocks 71c are not provided, the gray zone in which the FOVs (θ) of both optical detectors 21 overlap is remarkably decreased or eliminated, while allowing the detectable zones to be increased. As a result, the oblique optical block 71c disposed between the optical detectors 21 of the optical sensor chip 22 completely separates the detectable zones of both optical detectors 21 while decreasing the gray zone, thereby enabling effective detection of sensitive motion.

Here, as the largest portion at the top of the oblique optical block 71c increasingly protrudes, each FOV (θ) will be further restricted together with the detectable zones. Therefore, protrusion of the largest portion may be restricted in consideration of use of the motion gesture sensing module or design of a base device on which the motion gesture sensing module will be disposed. Preferably, the height of the oblique optical block 71c is the same as that of the sensor partition wall 82.

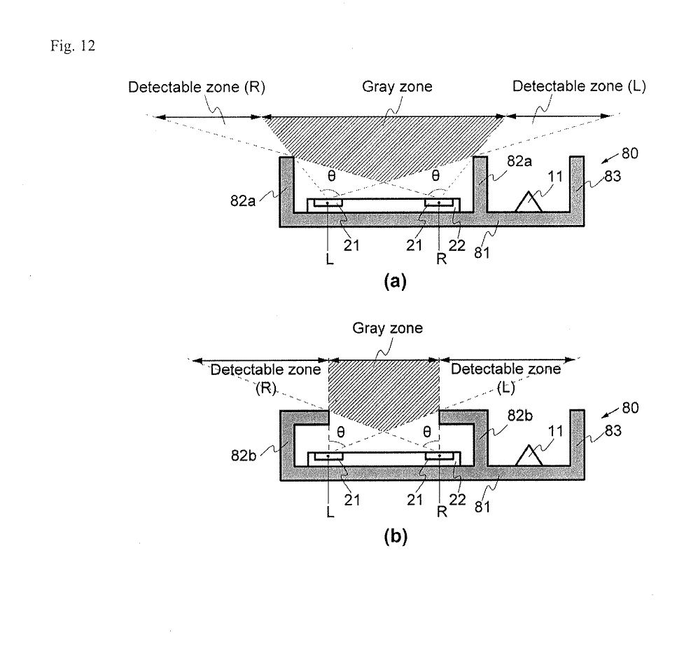

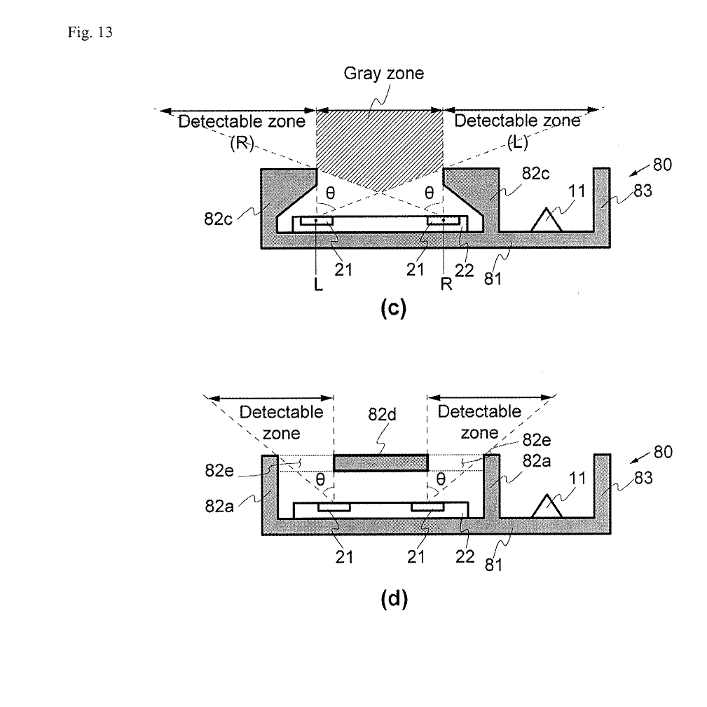

FIG. 12 and FIG. 13 are schematic cross-sectional views of a motion gesture sensing module according to a fourth embodiment of the present invention.

The motion gesture sensing module according to the fourth embodiment includes a single light source 11, a light sensor unit 20 provided as a single optical sensor chip 22 including at least two optical detectors 21, and a package 80 on which the light source 11 and the optical sensor chip 22 are mounted. Here, the package 80 serves to restrict the FOVs (θ) of the optical detectors 21.

That is, the package 80 may include a base 81 on which the light source 11 and the optical sensor chip 22 are mounted, sensor partition walls 82 protruding from outer circumferences of the optical sensor chip 22 to partition an installation region of the optical sensor chip 22, and a light source partition wall 83 protruding to partition an installation region of the light source 11.

Although FIG. 12 and FIG. 13 schematically shows the configuration of the motion gesture sensing module, which detects motion along a single axis using the optical sensor chip 22 including two optical detectors 21 and the package 80 serving as a partition for the optical sensor chip 22, it should be understood that the present invention is not limited thereto. The motion gesture sensing module according to the present invention may also detect motion along multiple axes using three or more optical detectors 21 and the package 80 for partitioning the same.

Here, the sensor partition wall 82 may be composed of an upright partition wall 82a, a bent partition wall 82b, an oblique partition wall 82c, and an upper partition wall 82d.

First, referring to FIG. 12(a), the optical sensor chip 22 is mounted on the base 81 of the package 80 partitioned by the upright partition walls 82a, the light source 11 is mounted on the base 81 of the package 80 partitioned by the light source partition wall 83, and two optical detectors 21 are disposed in the optical sensor chip 22.

The upright partition wall 82a has a higher height than the two optical detectors 21 of the optical sensor chip 22 and serves to restrict the FOVs (θ) of the optical detectors 21.

Referring to FIG. 12(a), the left (L) optical detector 21 and the right (R) optical detector 21 have their own FOVs (θ) restricted by adjacent upright partition walls 82a, respectively. Therefore, a portion in which the FOVs (θ) of both optical detectors 21 overlap becomes the gray zone, and each of the optical detectors 21 has its own detectable zone at an opposite side to its location. For example, the left (L) optical detector 21 has its own detectable zone L at a side of the right (R) optical detector 21, and the right (R) optical detector 21 has its own detectable zone R at a side of the left (L) optical detector 21.

As a result, as compared with the case where the left and right upright partition walls 82a are not provided, the gray zone in which the FOVs (θ) of the optical detectors 21 overlap is decreased, whereas the detectable zones are separated and increased. As a result, the upright partition walls 82a respectively disposed at the left and right sides of the optical detectors 21 of the optical sensor chip 22 separate the detectable zones of the optical detectors 21 while decreasing the gray zone, thereby enabling effective detection of sensitive motion.

Here, as the height of the upright partition wall 82a increases, the gray zone will be decreased together with the detectable zones. Therefore, the height of the upright partition wall 82a may be restricted in consideration of a connection structure and design of a base device on which the motion gesture sensing module will be disposed.

Further, only the package structure of the upright partition walls 82a without any separate optical block is sufficient to adjust the FOV (θ) of the optical detector, thereby providing effects of good strength, low cost and miniaturization.

Next, referring to FIG. 12(b), the optical sensor chip 22 is mounted on the base 81 of the package 80 partitioned by the bent partition walls 82b, the light source 11 is mounted on the base 81 of the package 80 partitioned by the light source partition wall 83, and two optical detectors 21 are disposed in the optical sensor chip 22.

Each of the bent partition walls 82b placed at opposite sides has a shape wherein a straight base is bent inward (that is, toward the optical detector) at an upper end thereof, and the extended portions are placed above the two optical detectors 21 of the optical sensor chip 22 and restrict the FOVs (θ) of the optical detectors 21. Here, distal ends of the extended portions at the upper ends of the bent partition walls 82b may be placed corresponding to detection central locations of the adjacent optical detector 21.

Referring to FIG. 12(b), the left (L) optical detector 21 and the right (R) optical detector 21 have their own FOVs (θ) restricted by the adjacent bent partition walls 82bb, respectively. Therefore, a portion in which the FOVs (θ) of both optical detectors 21 overlap becomes the gray zone, and each of the optical detectors 21 has its own detectable zone at an opposite side to its location. For example, the left (L) optical detector 21 has its own detectable zone L at a side of the right (R) optical detector 21, and the right (R) optical detector 21 has its own detectable zone R at a side of the left (L) optical detector 21.

As a result, as compared with the case where the left and right bent partition walls 82b are not provided, the gray zone in which the FOVs (θ) of the optical detectors 21 overlap is decreased, whereas the detectable zones are separated and increased. As a result, the bent partition walls 82b respectively disposed at the left and right sides of the optical detectors 21 separate the detectable zones of the optical detectors 21 while decreasing the gray zone, thereby enabling effective detection of sensitive motion.

Here, as the length of the extended portion bent at the upper end of each of the bent partition walls 82b increases, the gray zone will be decreased together with the detectable zones. Therefore, the length of the extended portion may be restricted in consideration of use of the motion gesture sensing module or design of a base device on which the motion gesture sensing module will be disposed.

Further, only the package structure of the bent partition walls 82b without any separate optical block is sufficient to adjust the FOV (θ) of the optical detector, thereby providing effects of good strength, low cost and miniaturization

Next, referring to FIG. 13(c), the optical sensor chip 22 is mounted on the base 81 of the package 80 partitioned by the oblique partition walls 82c, the light source 11 is mounted on the base 81 of the package 80 partitioned by the partition wall 83, and two optical detectors 21 are disposed in the optical sensor chip 22.

Each of the oblique partition walls 82c has a horizontal cross-section, the area of which increases upward, such that lateral sides of the oblique partition walls facing inward (that is, toward the optical detectors) can increase upward, thereby forming oblique lateral sides. Therefore, these lateral portions are operated to restrict the FOVs (θ) of the optical detectors 21. Here, the largest portion at the top of the oblique partition wall 82c may be formed corresponding to the central location of the optical detector 21.

Referring to FIG. 13(c), the left (L) optical detector 21 and the right (R) optical detector 21 have their own FOVs (θ) restricted by the adjacent oblique partition walls 82c, respectively. Therefore, a portion in which the FOVs (θ) of both optical detectors 21 overlap becomes the gray zone, and each of the optical detectors 21 has its own detectable zone at an opposite side to its relative location. For example, the left (L) optical detector 21 has its own detectable zone L at a side of the right (R) optical detector 21, and the right (R) optical detector 21 has its own detectable zone R at a side of the left (L) optical detector 21.

As a result, as compared with the case where the left and right oblique partition wall 82c are not provided, the gray zone in which the FOVs (θ) of the optical detectors 21 overlap is decreased, whereas the detectable zones are increased. As a result, the oblique partition walls 82c respectively disposed at the left and right sides of the optical detectors 21 increase the detectable zones of the optical detectors 21 while decreasing the gray zone, thereby enabling effective detection of sensitive motion.

Here, as the largest portion at the top of the oblique partition wall 82c increasingly protrudes, the gray zone will be decreased together with the detectable zone. Therefore, the largest portion may be restricted in consideration of a connection structure and design of a base device on which the motion gesture sensing module will be disposed.

Further, only the package structure of the oblique partition wall 82c without any separate optical block is sufficient to adjust the FOV (θ) of the optical detector, thereby providing effects of good strength, low cost and miniaturization.

Next, referring to FIG. 13(d), the optical sensor chip 22 is mounted on the base 81 of the package 80 partitioned by the upright partition walls 82a, the light source 11 is mounted on the base 81 of the package 80 partitioned by the partition wall 83, and two optical detectors 21 are disposed in the optical sensor chip 22. Further, the upper partition wall 82d having a light receiving hole is placed above and covers a region of the package 80 in which the optical sensor chip 22 is mounted.

Here, the upper partition wall 82d serves to cover the optical sensor chip 22 while the optical sensor chip 22 is placed in the package 80, and includes light receiving holes 82e at portions corresponding to the locations of the optical sensor chip 22.

Here, the upper partition wall 82d serves to restrict the FOVs (θ) of the optical detectors 21 in the optical sensor chip 22.

Referring to FIG. 13(d), the left (L) optical detector 21 and the right (R) optical detector 21 have their own FOVs (θ) restricted by the upper partition wall 82d, respectively. Therefore, the gray zone in which the FOVs (θ) overlap is substantially decreased or completely eliminated by adjusting the size of the upper partition wall 82d. As compared with the case where the upper partition wall 82d is not provided, the gray zone in which the FOVs (θ) of both optical detectors 21 overlap is remarkably decreased or eliminated, and the detectable zones are increased. As a result, the upper partition wall 82d disposed above the optical detectors 21 of the optical sensor chip 22 increases the detectable zones while decreasing the gray zone, thereby enabling effective detection of sensitive motion.

With this configuration, only the package structure of the upper partition wall 82d without any separate optical block is sufficient to adjust the FOV (θ) of the optical detector, thereby providing effects of good strength, low cost and miniaturization.

The foregoing embodiments illustrate and describe that motion gesture of a subject moving along a single axis is detected through two optical detectors 21. However, as mentioned above, it should be understood that the present invention may also be applied to detection of motion along multiple axes using at least three optical detectors 21.

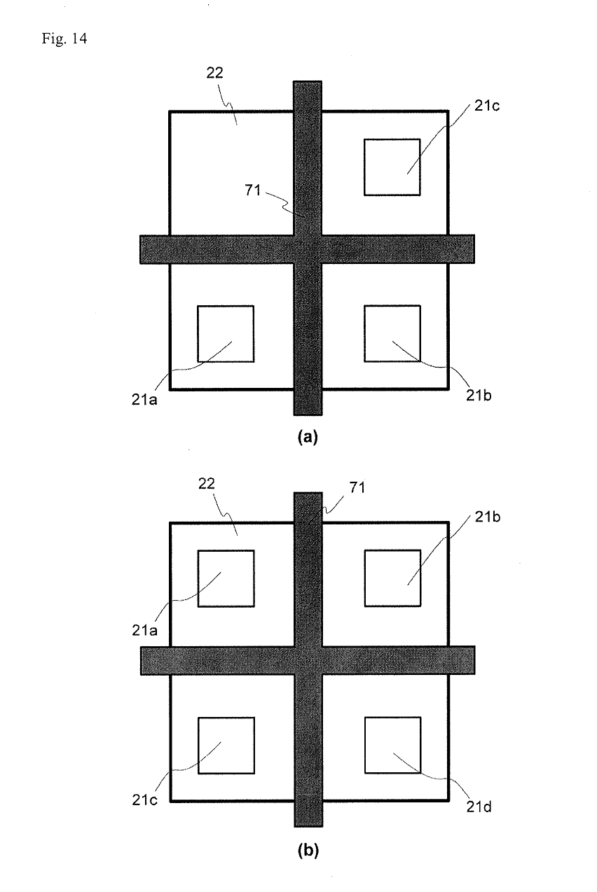

First, as described in the first embodiment (see FIG. 9) and the third embodiment (see FIG. 11), when the inner-wall type optical block 71 is disposed between the optical detectors 21, the inner-wall type optical block 71 may be formed to have a cross-shape, as shown in FIGS. 14 (a) and (b), thereby partitioning the optical detectors 21.

Referring to FIG. 14, the optical detectors 21 are disposed in three or four quadrants of the optical sensor chip 22 having an approximately rectangular shape, and the inner-wall type optical block 71 having a cross-shape is arranged to quadrisect the optical sensor chip 22.

The inner-wall type optical block 71 having a cross-shape has a higher height than the optical detector 21 of the optical sensor chip 22 and serves to restrict the FOV (θ) of each of the optical detectors 21.

With this structure, when three optical detectors are provided, as shown in FIG. 14(a), the FOV (θ) of a first optical detector 21a is adjusted to a left lower side by the inner-wall type optical block 71 having a cross-shape, thereby sensing motion gesture of a subject moving at the left and lower sides of the motion gesture sensing module. Further, the FOV (θ) of a second optical detector 21b is adjusted to a right lower side by the inner-wall type optical block 71 having a cross-shape, thereby sensing the motion gesture of the subject moving at the right and lower sides of the motion gesture sensing module. In addition, the FOV (θ) of a third optical detector 21c is adjusted to a right upper side by the inner-wall type optical block 71 having a cross-shape, thereby sensing the motion gesture of the subject moving at the right and upper sides of the motion gesture sensing module.

In general, leftward and rightward motions of a subject can be sensed by the first optical detector 21a and the second optical detector 21b, and upward and downward motions of the subject can be sensed by the third optical detector 21c and the second optical detector 21b, thereby distinguishably sensing the motion gesture of the subject moving along multiple axes. In particular, the inner-wall type optical block 71 having the cross-shape partitions the detectable zones of the optical detectors, and decreases the gray zone, thereby more sensitively detecting the gesture.

In addition, when four optical detectors are provided as shown in FIG. 14(b), two left and right detectors (for example, 21a, 21b, 21c, 21d) can sense the motion gesture of the subject moving in left and right spaces. Likewise, two upper and lower detectors (for example, 21a, 21c, 21b, 21d) can sense the motion gesture of the subject moving in upper and lower spaces.

Here, FIG. 14 shows that the inner-wall type optical block 71 having the cross-shape is provided in the form of the upright optical block 71a, without being limited thereto. The inner-wall type optical block 71 may be provided in the form of the bent optical block 71b or the oblique optical block 71c.

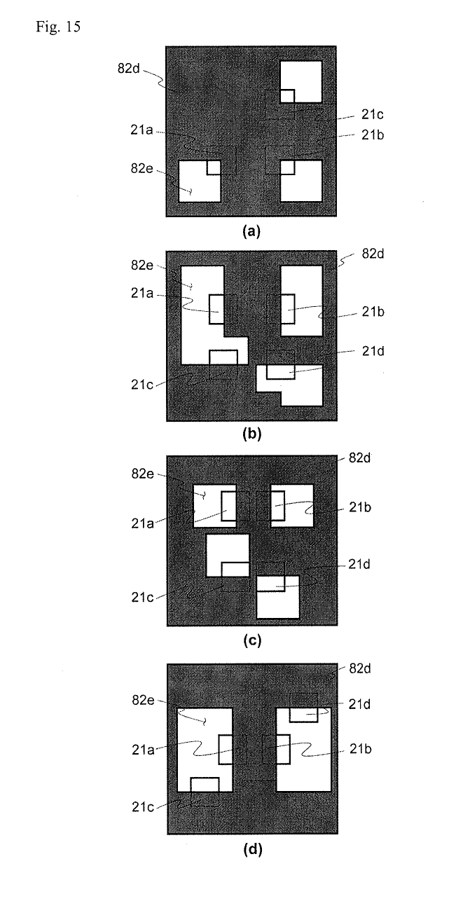

FIG. 15 is a view explaining various shapes of the upper partition wall 82d and the light receiving hole 82e described with reference to FIG. 12(d), and examples of arranging the optical detectors based on the shapes thereof. At this time, the upper partition wall 82d may be a cover connected to the partition walls surrounding the outer circumferences of the light sensor unit including the optical detectors 21a, 21b, 21c and covering the light sensor unit. The cover is formed with at least one light receiving hole. By the cover formed with the light receiving hole, each of the optical detectors is partially covered or partially exposed through the light receiving hole. As shown in FIG. 15, a boundary of each light receiving hole may be placed at the center of each of the optical detectors 21a, 21b, 21c, or 21d.

First, referring to FIG. 15(a), three optical detectors 21a, 21b, 21c are provided and the upper partition wall 82d is formed with three light receiving holes 82e. Here, three light receiving holes 82e are provided to open a left and lower portion of the first optical detector 21a, a right lower portion of the second optical detector 21b, and a right upper portion of the third optical detector 21b, such that the optical detector can detect light through the open portions.

Therefore, the first optical detector 21a and the second optical detector 21b can detect the motion gesture of the subject moving in the left and right spaces, and the third optical detector 21c and the second optical detector 21b can detect the motion gesture of the subject in the upper and lower spaces.

Next, referring to FIG. 15(b), four optical detectors 21a, 21b, 21c, 21d are provided, and the upper partition wall 82d is formed with three light receiving holes 82e. Here, three light receiving holes 82e are provided to open a left portion of the first optical detector 21a, a right portion of the second optical detector 21b, an upper portion of the third optical detector 21b, and a lower portion of the fourth optical detector 21d such that the optical detectors can detect light through the open portions.

Therefore, the first optical detector 21a and the second optical detector 21b can detect the motion gesture of the subject moving in the left and right spaces, and the third optical detector 21c and the fourth optical detector 21d can detect the motion gesture of the subject in the upper and lower spaces.

Next, referring to FIG. 15(c), four optical detectors 21a, 21b, 21c, 21d are provided, and the upper partition wall 82d is formed with four light receiving holes 82e. Here, four light receiving holes 82e are provided to open a left portion of the first optical detector 21a, a right portion of the second optical detector 21b, an upper portion of the third optical detector 21b, and a lower portion of the fourth optical detector 21d such that the optical detectors can detect light through the open portions.

Therefore, the first optical detector 21a and the second optical detector 21b can detect the motion gesture of the subject moving in the left and right spaces, and the third optical detector 21c and the fourth optical detector 21d can detect the motion gesture of the subject in the upper and lower spaces.

Next, referring to FIG. 15(d), four optical detectors 21a, 21b, 21c, 21d are provided, and the upper partition wall 82d is formed with two light receiving holes 82e. Here, two light receiving holes 82e are provided to open a left portion of the first optical detector 21a, a right portion of the second optical detector 21b, an upper portion of the third optical detector 21b, and a lower portion of the fourth optical detector 21d such that the optical detectors can detect light through the open portions.

Therefore, the first optical detector 21a and the second optical detector 21b can detect the motion gesture of the subject moving in the left and right spaces, and the third optical detector 21c and the fourth optical detector 21d can detect the motion gesture of the subject in the upper and lower spaces.

It will be understood that such arrangement of the optical detectors and the shapes of the light receiving holes may be changed in various ways in addition to those shown in FIG. 15, within the scope of the present invention.

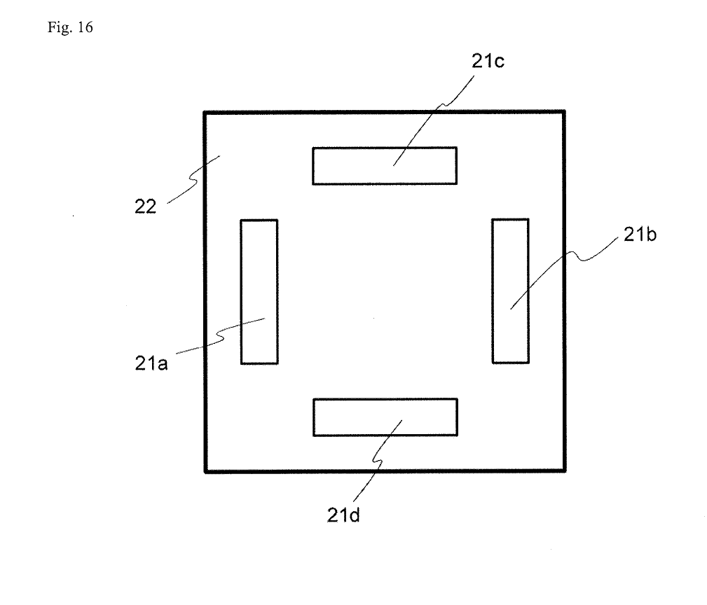

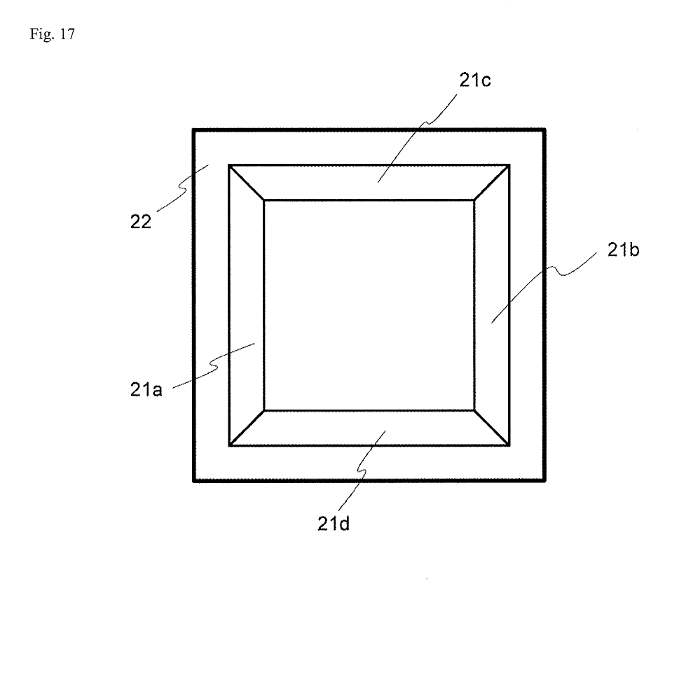

Then, four optical operators 21 are arranged as shown in FIG. 16 and FIG. 17 to detect motion gesture of a subject moving along multiple axes.

Referring to FIG. 16, four optical detectors 21a, 21b, 21c, 21d are provided and symmetrically arranged at upper, lower, left and right sides. The light sensor unit is generally realized by the optical sensor chip 22. The optical detectors 21a, 21b, 21c, 21d are respectively arranged at four quadrants on the optical sensor chip 22 having an approximately rectangular shape. FIG. 17 shows an alternative example wherein the optical detectors 21a, 21b, 21c, 21d are arranged to contact each other at distal ends thereof.

With this structure, the first optical detector 21a has the FOV (θ) biased leftward, thereby detecting the motion gesture of the subject moving in the left space of the motion gesture sensing module.

Further, the second optical detector 21b has the FOV (θ) biased rightward, thereby detecting the motion gesture of the subject moving in the right space of the motion gesture sensing module.

Further, the third optical detector 21c has the FOV (θ) biased upward, thereby detecting the motion gesture of the subject moving in the upper space of the motion gesture sensing module.

Further, the fourth optical detector 21d has the FOV (θ) biased downward, thereby detecting the motion gesture of the subject moving in the lower space of the motion gesture sensing module.

In general, the leftward and rightward motions of the subject can be sensed by the first optical detector 21a and the second optical detector 21b, and the upward and downward motions of the subject can be sensed by the third optical detector 21c and the second optical detector 21b, thereby distinguishably sensing all of the motion gestures of the subject moving along the multiple axes. This is the same as the examples of FIG. 17.

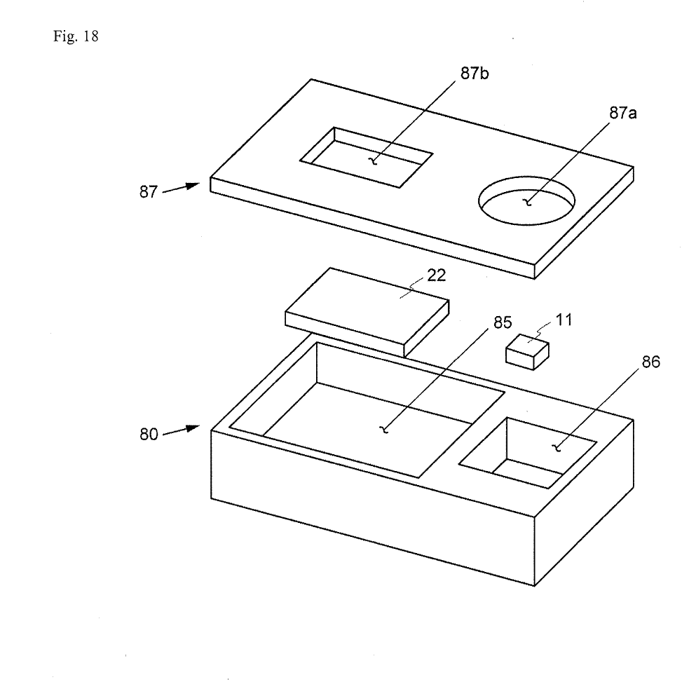

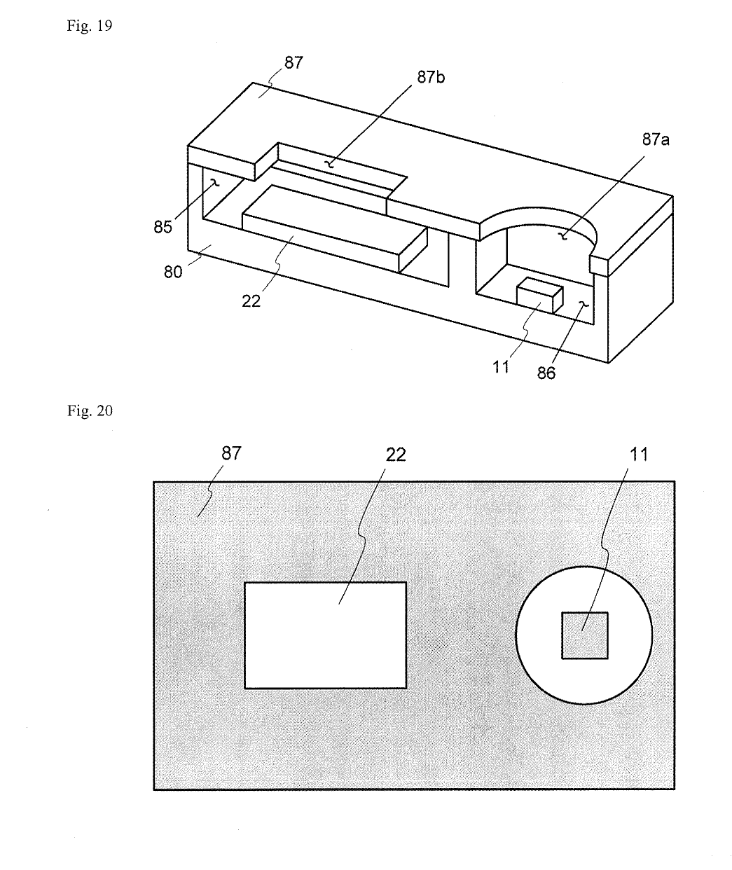

Next, a motion gesture sensing module according to a fifth embodiment based on the principle of the present invention will be described with reference to FIG. 18 to FIG. 21

First, referring to FIG. 18 to FIG. 21, the motion gesture sensing module according to the fifth embodiment may include a package 80 including two accommodation spaces opened upward; an optical sensor chip 22 and a light source 11 accommodated in the accommodation spaces of the package 80; and a cover 87 covering an upper portion of the package 80. The cover 87 may be realized by an extended portion bent inward and extending from an upper portion of a package partition wall.

The package 80 includes a sensor chip accommodating portion 85 open upward for accommodating the optical sensor chip 22 therein, and a light source accommodating portion 86 open upward for accommodating the light source 11 therein.

Here, the sensor chip accommodating portion 85 and the light source accommodating portion 86 are formed to accommodate the optical sensor chip 22 and the light source 11 therein, and have horizontal sizes larger than the horizontal sizes of the optical sensor chip 22 and the light source 11, respectively.

The optical sensor chip 22 may include two optical detectors to sense motion gesture of a subject moving along a single axis, or three or more optical detectors to sense the motion gesture of the subject moving along multiple axes.

The cover 87 serves to cover the upper portion of the package 80 accommodating the optical sensor chip 22 and the light source 11 therein, and is formed with a light emitting hole 87a corresponding to a location of the light source 11 and a light receiving hole 87b corresponding to a location of the optical sensor chip 22.

Here, the light emitting hole 87a has a circular shape and serves as a passage through which light emitted from the light source 11 travels to the outside of the package 80. Preferably, the light emitting hole 87a has a larger diameter than the light source 11 such that light emitted from the light source 11 can be smoothly emitted to the outside of the package 80. An emitting angle of the light source 11 may be adjusted by adjusting the diameter of the light emitting hole 87a, whereby an operation range of the motion gesture sensing module can be adjusted.

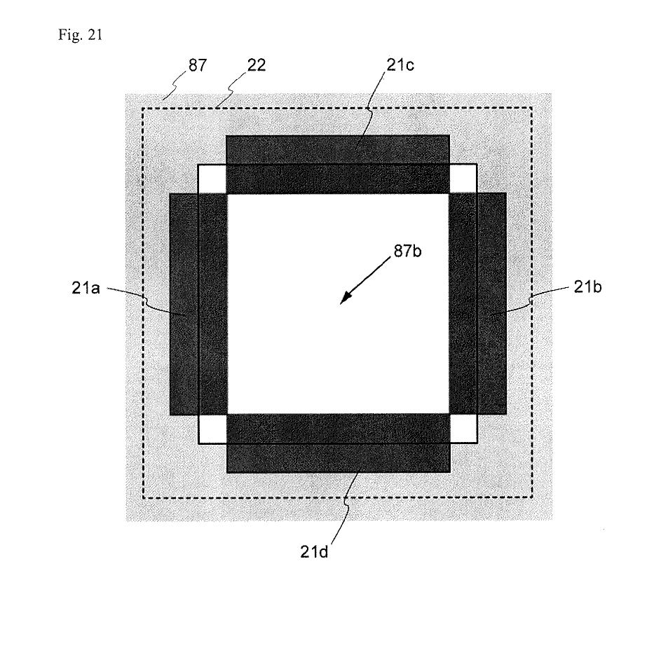

In addition, the light receiving hole 87b has a quadrangular shape, and the cover 87 around the light receiving hole 87b acts as an optical block to restrict the FOVs (θ) of the optical detectors 21 within the optical sensor chip 22. Preferably, the cover 87 formed with the light receiving hole 87b partially covers each of the optical detectors while partially exposing each of the optical detectors through the light receiving hole 87b. As shown in FIG. 21, preferably, the boundary of the light receiving hole is placed over the center of each of the optical detectors 21a, 21b, 21c, 21d.

Preferably, the size of the light receiving hole 87b is smaller than that of the optical sensor chip 22. More preferably, the size of the light receiving hole 87b is determined to be more inclined inward (that is, toward the center) than the location of each of the optical detectors 21 of the optical sensor chip 22.

This structure will be described in detail with reference to FIG. 21.

FIG. 21 shows a structure wherein the optical sensor chip 22 includes four optical detectors by way of example. It will be appreciated from the following descriptions that the principle of restricting the FOV by adjusting the diameter of the light receiving hole 87b in the cover 87 is equivalently applicable to the structure of three optical detectors and the structure of two optical detectors.

In FIG. 21, the optical sensor chip 22 includes four optical detectors 21a, 21b, 21c, 21d respectively arranged at four quadrants of the optical sensor chip 22. Further, when viewed from above, the light receiving holes 87b of the cover 87 are configured such that outer edges of the upper, lower, left and right light receiving holes 87b can be placed at the centers of four optical detector 21a, 21b, 21c, 21d, respectively.

Therefore, the cover 87 operates like the bent upper end of the bent partition wall 82b described in FIG. 12(b), whereby the cover 87 around the light receiving hole 87b can restrict the FOVs (θ) of four optical detectors 21a, 21b, 21c, 21d.

As a result, the respective optical detectors 21a, 21b, 21c, 21d have detectable zones at both sides of the opposite optical detector, and the FOVs (θ) overlap to form the gray zone above the corresponding light receiving holes 87b.

Therefore, the gray zone in which the FOVs (θ) of the four optical detector 21a, 21b, 21c, 21d overlap is decreased into a small zone (above the light receiving hole), whereas the detectable zones are increased.

With this structure, only the package 80 and the cover 87 without any separate optical block is sufficient to adjust the FOV (θ) of the optical detector, thereby providing effects of good strength, low cost and miniaturization.

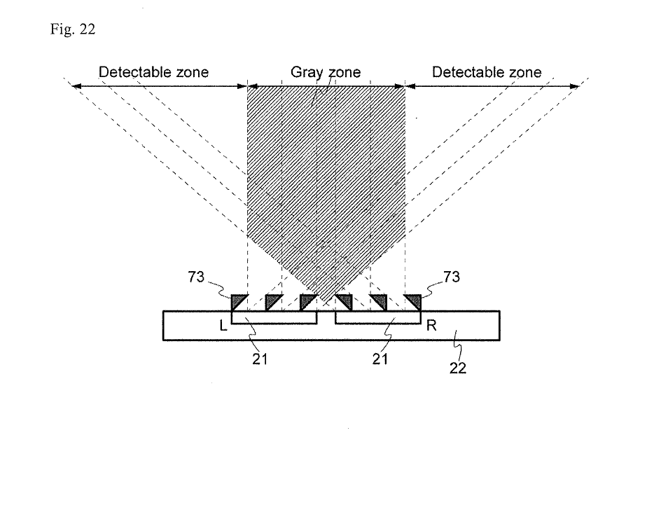

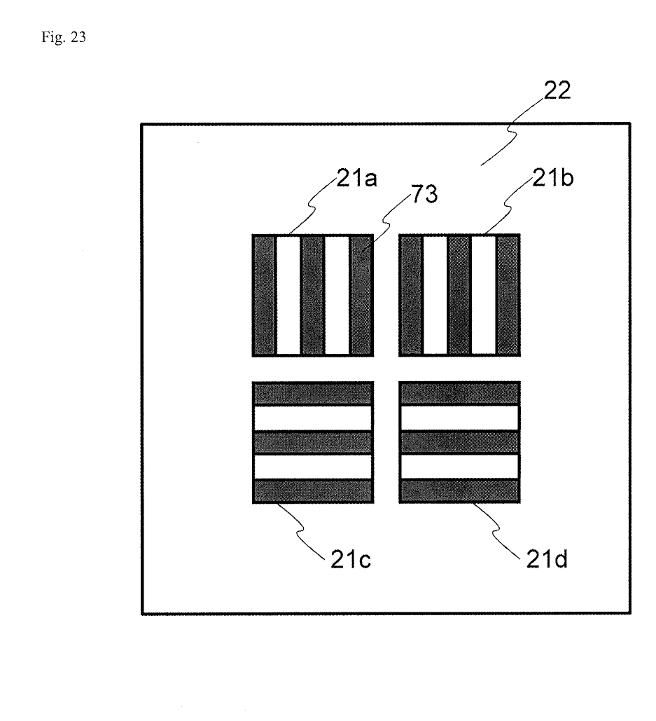

FIG. 22 and FIG. 23 are views explaining an alternative optical sensor chip based on the principle of the optical block according to the present invention. FIG. 22 is a cross-sectional view of the optical sensor chip, and FIG. 23 is a plan view of the optical sensor chip.

Here, the light sensor unit 20 is realized by one optical sensor chip 22 including at least two optical detectors 21, in which a plurality of sectional optical blocks 73 is disposed above the optical detector 21.

As shown in FIG. 23, the plural parallel sectional optical blocks 73 are arranged above one optical detector 21, and each sectional optical block 73 serves to restrict the FOV (θ) of the corresponding optical detector 21, more particularly, to separate the detectable zone of the optical detector 21.

In particular, as shown in FIG. 22, each sectional optical block 73 has an oblique shape, a horizontal cross-section of which increases upward, and thus the FOV can be set up to a certain direction depending upon shapes of the cross-section.

That is, in FIG. 22, the sectional optical block 73 corresponding to the left (L) optical detector 21 has a lateral side that faces rightward and increasingly protrudes upward to form an oblique lateral side. On the other hand, the sectional optical block 73 corresponding to the right (R) optical detector 21 has a lateral side that faces leftward and increasingly protrudes upward to form an oblique lateral side. Therefore, the optical detector 21 has a plurality of separated detectable zones, in which the left (L) optical detector 21 and the right (R) optical detector 21 have the detectable zones in different directions.

Here, the detectable zone and detecting direction of the optical detector 21 may vary by changing the cross-section of the sectional optical blocks 73 or the arranging direction of the sectional optical blocks 73 (see FIG. 23).

In this structure, a sectional optical block having a relatively low height is used without a separate optical block having a relatively high height, thereby providing advantages in miniaturization of the motion gesture sensing module while enabling more sensitively detection of motion of a subject.

FIG. 22 shows the sectional optical bock 73 for setting up two optical detectors 21 to have detectable zones in different directions from each other (that is, leftward and rightward directions), without being limited thereto. Alternatively, the sectional optical blocks 73 may be disposed to set the detectable zones of at least two optical detectors 21 in at least two directions (that is, leftward, rightward, upward and downward directions) depending upon the cross-section shapes of the sectional optical blocks 73.

Alternatively, the sectional optical blocks 73 may be disposed to set the detectable zones of at least two optical detectors 21 in at least two directions (that is, leftward, rightward, diagonal and zenithal directions) depending upon arrangement (that is, lengthwise, breadthwise, and diagonal arrangements) of the sectional optical blocks 73.

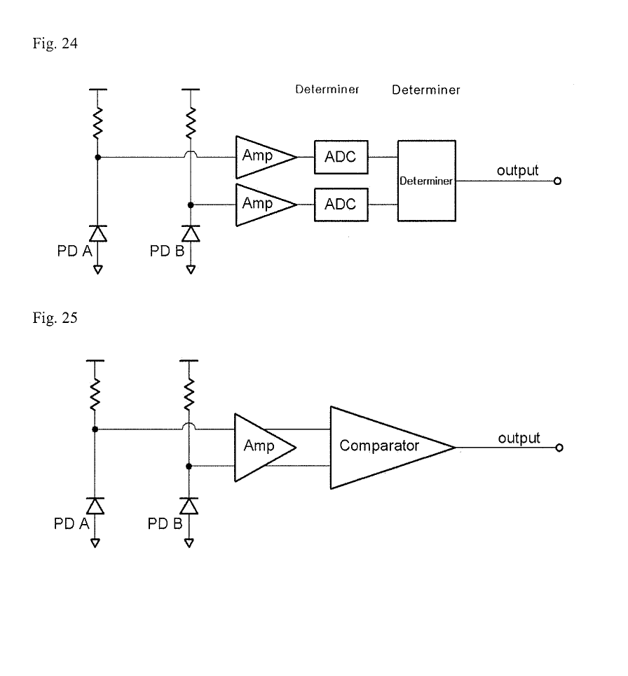

On the other hand, the basic principle of the present invention is that the respective optical detectors are configured to receive different quantities of light in accordance with locations of subjects. The respective optical detectors receive light reflected from the subject and generate electric energy in proportion to the received quantities of light. Then, as shown in FIG. 24, the sensor processor disposed in the optical detector receives analog electric energy of the corresponding optical detector PD, amplifies the analog electric energy through an amplifier AMP, converts the amplified energy into digital data through an analog-digital converter ADC, and transmits the digital data to a determiner. Then, the determiner compares the quantities of light detected by the respective optical detectors PDs, and determines the current location or motion of the subject, thereby transmitting information about the determined location and motion to the base device.

Thus, the determiner determines detailed upward, downward, leftward and rightward motions of the subject by comparing the qualities of light between the respective optical detectors, thereby sensing a rotational (i.e., clockwise or counterclockwise) direction or touch in space (i.e., click) of the subject based on the motion of the subject.

Here, when the motion gesture sensing module according to the invention is applied to a portable device, the above configuration of the sensor processor must be improved to reduce power consumption. In addition, when the light source is a light emitting diode (LED), the LED consumes tens to hundreds of mA when driven, thereby causing power noise and ground noise. To overcome such noise, the configuration of the sensor processor may be improved, as shown in FIG. 25.

Referring to FIG. 25, the sensor processor disposed in the optical detector receives the analog electric energy of the optical detector PD and amplifies the analog electric energy through the amplifier AMP, in which a condenser (not shown) is used to change the amplifier AMP into a differential circuit and thus a differential waveform is transmitted to a comparator. Then, the comparator compares the received differential waveforms and outputs a logic-level comparator output. The comparator output is used as a basis for determining the direction and is transmitted to a base device or separate determiner. Here, the comparator may be a hysteresis comparator that can solve the unstable output due to noise.

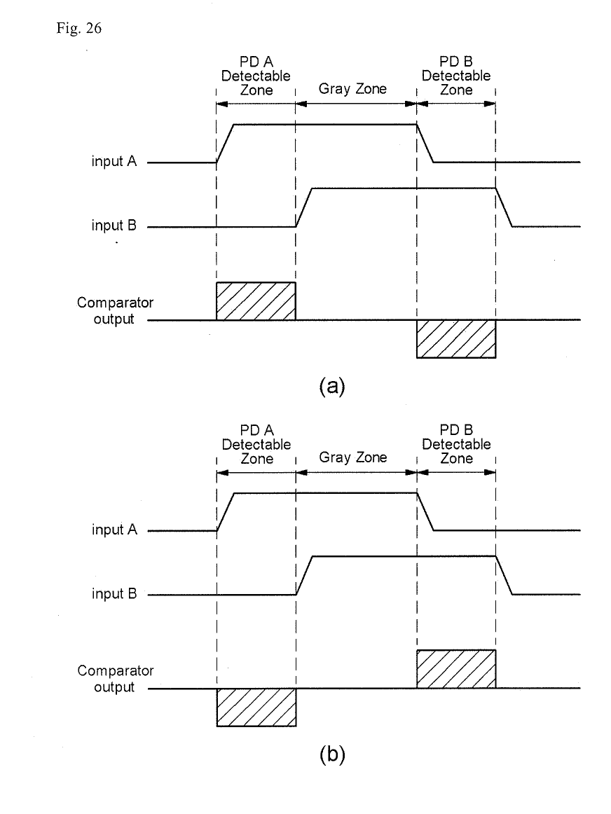

FIG. 26 shows one example of an output waveform from the sensor process shown in FIG. 25. FIG. 26 shows a forward motion (a) and a backward motion (b) with respect to a single axis (for example, an X-axis).

In FIG. 26(a), it is assumed that a subject moves from a detectable zone of the optical detector A (PD A) to the detectable zone of the optical detector B (PD B).

Referring to FIG. 26(a), in the detectable zone of the optical detector A (PD A), first, the optical detector A (PD A) detects a motion within its own FOV, and the optical detector B (PD B) detects no motion. Thus, the comparator outputs the presence of an input signal A within the corresponding section. Next, in the gray zone in which both the optical detector A (PD A) and the optical detector B (PD B) detect the subject, the optical detector A (PD A) and the optical detector B (PD B) detect motion within their own FOVs. Thus, the comparator outputs no value within the corresponding section due to the presence of both input signals A and B. Last, in the detectable zone of the optical detector B (PD B), the optical detector B (PD B) detects motion within its own FOV and the optical detector A (PD A) detects no motion. Accordingly, the comparator outputs the presence of an input signal B within the corresponding section.

On the other hand, FIG. 26(b) shows that detection of the optical detector A (PDA) and the optical detector B (PD B) with regard to motion in an opposite direction to that of FIG. 26(a) and the corresponding output of the comparator.

In the sensor processor of FIG. 25, only a simple comparator is used without employing the analog-digital converter of FIG. 24, and it is thus possible to provide a motion gesture sensing module that can be driven with low power while remarkably improving resistance to power noise and ground noise. Further, a motion sensing distance is also increased.

This motion gesture sensing module may include an illumination sensor.

The illumination sensor measures brightness or quantity of light around the corresponding gesture sensing module, and generates an illumination value. Such an ambient illumination value may be compared with a certain reference to automatically control whether to drive or hold the motion gesture sensing module.

The illumination sensor employs a light receiving element including a photodiode to measure an ambient quantity of light such that the determiner or the controller can receive the measured illumination value and determine and control whether to drive or hold the motion gesture sensing module.

In the aforementioned embodiments, the motion gesture sensing module according to the present invention receives input of a control signal corresponding to a user's motion by sensing a spatial motion without contact, instead of user's direct touch, and thus can be optimized as a new input interface for portable communication devices such as smart phones, cellular phones, and the like; and portable information terminals such as personal digital assistants (PDAs), handheld personal computers (PCs), notebook computers, laptop computers, WiBro terminals, MP3 players, MD players, etc.

In particular, the motion gesture sensing module according to the present invention may provide a reading mode for monitoring user’ use of the corresponding device and determining a display state of a display when the sensing module is applied to a display device such as a smart phone.

Here, the reading mode determines whether a user views a screen displayed on the display, thereby determining whether to maintain the display state, i.e. the driving state of the screen.

Basically, while a user views the screen of the display, a distance between the screen and the user is relatively short and there is no sudden motion of the user.

Therefore, in the motion gesture sensing module according to the present invention with the structure wherein at least one light source emits light and the light reflected from the subject is received by at least one optical detector, the reading mode is maintained in accordance with intensity of received light, thereby continuously driving the screen. This is because a distance between the display device (more specifically, the motion gesture sensing module) and a user is relative short while the user is viewing the screen of the display device, and the optical detector can receive light of relatively strong intensity.

Additionally, in the motion gesture sensing module according to the present invention with the structure wherein at least one light source emits light and the light reflected from the subject is received by at least one optical detector, the reading mode is maintained if there is no relative motion of the subject, thereby continuously driving the screen. This is because there is no sudden motion of a user while the user is viewing the screen of the display device.

Although some embodiments have been described above, it should be understood that these embodiments are given by way of illustration only, and that various modifications, variations, and alterations can be made without departing from the spirit and scope of the invention. Therefore, the scope of the invention should be limited only by the accompanying claims and equivalents thereof.

1. A motion gesture sensing module comprising:
a light source emitting light; and
a light sensor unit comprising at least two optical detectors sensing light reflected from a subject,
wherein each of the optical detectors of the light sensor unit has an individually separated detectable zone.

2. The motion gesture sensing module according to claim 1, comprising:
an optical block disposed in a light receiving path of the light sensor unit and separating a detectable zone of each of the optical detectors.

3. The motion gesture sensing module according to claim 2, wherein the optical block is arranged to increase a detectable zone of each of the optical detectors while decreasing a gray zone in which fields of view (FOVs) of the respective optical detectors overlap.

4. The motion gesture sensing module according to claim 2, wherein the optical block comprises an inner-wall type optical block disposed between the respective optical detectors.

5. The motion gesture sensing module according to claim 4, wherein the inner-wall type optical block comprises an upright optical block.

6. The motion gesture sensing module according to claim 4, wherein the inner-wall type optical block has an extended portion bent at an upper end thereof in a horizontal direction.

7. The motion gesture sensing module according to claim 4, wherein the inner-wall type optical block comprises an oblique optical block having a horizontal cross-section, the area of which increases upward.

8. The motion gesture sensing module according to claim 4, wherein the inner-wall type optical block has a bottom separated from an upper end of the light sensor unit.

9. The motion gesture sensing module according to claim 2, wherein the optical block comprises an outer-wall type optical block disposed at an outer circumference of the optical detector.

10. The motion gesture sensing module according to claim 9, wherein the outer-wall type optical block comprises an upright optical block.

11. The motion gesture sensing module according to claim 9, wherein the outer-wall type optical block has an extended portion bent inward at an upper end thereof in a horizontal direction.

12. The motion gesture sensing module according to claim 9, wherein the outer-wall type optical block comprises an oblique optical block having a horizontal cross-section, the area of which increases upward.

13. The motion gesture sensing module according to claim 1, wherein the light sensor unit comprises at least three optical detectors, at least two of which are arranged in horizontal or vertical directions to detect relative motion of a subject moving along multiple axes.

14. The motion gesture sensing module according to claim 13, wherein the light sensor unit comprises four optical detectors symmetrically arranged at upper, lower, left and right sides.

15. The motion gesture sensing module according to claim 14, wherein the four optical detectors are arranged to contact each other at distal ends thereof.

16. The motion gesture sensing module according to claim 13, comprising:
an optical block disposed in a light receiving path of the light sensor unit and separating a detectable zone of each of the optical detectors.

17. The motion gesture sensing module according to claim 16, wherein the optical block comprises an inner-wall type optical block disposed between the respective optical detectors.

18. The motion gesture sensing module according to claim 16, wherein the optical block comprises an outer-wall type optical block disposed at an outer circumference of the optical detector.

19. The motion gesture sensing module according to claim 18, wherein the outer-wall type optical block has an extended portion bent inward at an upper portion thereof in a horizontal direction.

20. The motion gesture sensing module according to claim 2, wherein the light source and the light sensor unit are disposed in a package partitioned by a partition wall, and an inner-wall type optical block is disposed between the optical detectors on the light sensor unit.

21. The motion gesture sensing module according to claim 20, wherein the inner-wall type optical block comprises an upright optical block.

22. The motion gesture sensing module according to claim 20, wherein the inner-wall type optical block has an extended portion bent at an upper end thereof in a horizontal direction.

23. The motion gesture sensing module according to claim 20, wherein the inner-wall type optical block comprises an oblique optical block having a horizontal cross-section, the area of which increases upward.

24. The motion gesture sensing module according to claim 20, wherein the light sensor unit comprises an optical sensor chip including at least two optical detectors.

25. The motion gesture sensing module according to claim 2, wherein the optical block comprises a partition wall of a package on which the light sensor unit is mounted.

26. The motion gesture sensing module according to claim 25, wherein the partition wall comprises an upright partition wall disposed at an outer circumference of the light sensor unit.

27. The motion gesture sensing module according to claim 25, wherein the partition wall comprises an upright partition wall disposed at an outer circumference of the light sensor unit and having an extended portion bent inward at an upper portion thereof.

28. The motion gesture sensing module according to claim 25, wherein the partition wall comprises an oblique partition wall disposed at an outer circumference of the light sensor unit and having a horizontal cross-section, the area of which increases upward.

29. The motion gesture sensing module according to claim 2, wherein the light sensor unit is mounted in a package, and
the package comprises a partition wall surrounding an outer circumference of the light sensor unit, and a cover covering the light sensor unit as an optical block, the cover being connected to the partition wall and formed with at least one light receiving hole.

30. The motion gesture sensing module according to claim 29, wherein the cover has an extended portion bent inward at an upper portion of the partition wall.

31. The motion gesture sensing module according to claim 29, wherein the optical block is arranged to increase a detectable zone of each of the optical detectors while decreasing a gray zone in which fields of view (FOVs) of the respective optical detectors overlap.

32. The motion gesture sensing module according to claim 29, wherein the cover formed with at least one light receiving hole partially covers each of the optical detectors and partially exposes each of the optical detectors through the light receiving hole.

33. The motion gesture sensing module according to claim 32, wherein a boundary of the light receiving hole is placed over a center of each of the optical detectors.

34. The motion gesture sensing module according to claim 25, wherein the light sensor unit comprises an optical sensor chip including at least two optical detectors.

35. The motion gesture sensing module according to claim 29, wherein the light sensor unit comprises at least three optical detectors, at least two of which are arranged in horizontal or vertical directions to detect relative motion of a subject moving along multiple axes.

36. The motion gesture sensing module according to claim 2, comprising:
a package comprising two accommodation spaces; and
a light sensor unit and a light source respectively mounted in the accommodation spaces of the package,
wherein the package comprises a partition wall surrounding an outer circumference of the light sensor unit, and a cover covering the light sensor unit as an optical block, the cover being connected to the partition wall and formed with at least one light receiving hole.

37. The motion gesture sensing module according to claim 36, wherein the light sensor unit comprises an optical sensor chip including at least two optical detectors.

38. The motion gesture sensing module according to claim 36, wherein the cover has an extended portion bent inward at an upper portion of the partition wall.

39. The motion gesture sensing module according to claim 36, wherein the optical block increases a detectable zone of each of the optical detectors while decreasing a gray zone in which fields of view (FOVs) of the respective optical detectors overlap.

40. The motion gesture sensing module according to claim 36, wherein the cover formed with at least one light receiving hole partially covers each of the optical detectors and partially exposes each of the optical detectors through the light receiving hole.

41. The motion gesture sensing module according to claim 36, wherein a boundary of the light receiving hole is placed over a center of each of the optical detectors.

42. The motion gesture sensing module according to claim 36, wherein the light sensor unit comprises at least three optical detectors, at least two of which are arranged in horizontal and vertical directions to detect relative motion of a subject moving along multiple axes.

43. The motion gesture sensing module according to claim 2, wherein a plurality of sectional optical blocks is disposed above each of the optical detectors and individually separates a detectable zone of each of the optical detectors.

44. The motion gesture sensing module according to claim 43, wherein a direction of a field of view (FOV) is set depending upon shapes of the sectional optical blocks.

45. The motion gesture sensing module according to claim 43, wherein a direction of a field of view (FOV) is set depending upon arrangement of the sectional optical blocks.

46. A motion gesture sensing module comprising:
a light source emitting light;
a light sensor unit comprising at least two optical detectors sensing light reflected from a subject; and
a sensor processor transmitting an output of the light sensor unit to a motion determiner,
wherein the sensor processor comprises an amplifier and a comparator, the amplifier comprising a differential circuit to transmit a differential waveform to the comparator, the comparator being operated based on comparison with the received differential waveform.

47. The motion gesture sensing module according to claim 46, wherein the comparator comprises a hysteresis comparator.

48. A motion gesture sensing method that is a contactless motion sensing method, in which a light source emits light, light reflected from a subject is received by at least two optical detectors, and outputs of respective optical detectors are compared to determine a motion of a subject, the method comprising:
sensing the motion of the subject by individually separating a detectable zone of each of the optical detectors and receiving the light reflected from the subject.

49. The motion gesture sensing method according to claim 48, wherein an optical block is disposed in a light receiving path of the optical detector to individually divide the detectable zone of each of the optical detectors.

50. The motion gesture sensing method according to claim 48, wherein an optical block is arranged to increase a detectable zone of each of the optical detectors while decreasing a gray zone in which fields of view (FOVs) of the respective optical detectors overlap.
